(19) United States
(12) Patent Application Publication
(10) Pub. No.: US 2026/0195012 A1
(43) Pub. Date: Jul. 9, 2026

(54) PRECISION DYNAMIC PROXY CURSOR INTERFACE UTILIZING TENSION-BASED VISUAL FEEDBACK

(71) Applicant: 52 Stairs Studio Inc., Lasalle (CA)

(72) Inventor: Jonathan Wagner, Lasalle (CA)

(21) Appl. No.: 19/445,060

(22) Filed: Jan. 9, 2026

Related U.S. Application Data
(60) Provisional application No. 63/743,259, filed on Jan. 9, 2025.

(51) Int. Cl. G06F 3/041; G06F 3/044

(52) U.S. Cl. CPC G06F 3/04186; G06F 3/044

(57) ABSTRACT

A method for precision touch input on a touchscreen device may detect an initial touch at a first location as a starting point and detect movement to a current location. A tension value may be computed based on distance between the starting point and current location. A visual indicator may be rendered between the locations with visual properties that vary as a function of the tension value. The method may compare the tension value to a predefined threshold and maintain a cursor at the starting point while below the threshold. When the tension value meets or exceeds the threshold, the visual indicator may indicate an engaged state and cursor movement may be enabled with an offset from the current location such that the cursor is visually separated from the touch. The system may include a touchscreen display, processor, and memory storing instructions to perform these operations.

### RELATED APPLICATION

Under provisions of 35 U.S.C. § 119(e), the Applicant claims benefit of U.S. Provisional Application No. 63/743,259 filed on Jan. 9, 2025, and having inventors in common, which is incorporated herein by reference in its entirety.

It is intended that the referenced application may be applicable to the concepts and embodiments disclosed herein, even if such concepts and embodiments are disclosed in the referenced application with different limitations and configurations and described using different examples and terminology.

### FIELD OF DISCLOSURE

The present disclosure generally relates to touchscreen user interfaces and precision input methods for touch-sensitive display devices. More particularly, the disclosure relates to systems, methods, and apparatus for providing enhanced cursor control on touchscreen devices through tension-based visual feedback mechanisms that enable fine-grained manipulation with offset cursor positioning to prevent finger occlusion.

### BACKGROUND

Conventional touchscreen systems employ direct manipulation interfaces. A user's finger contacts the display surface at the intended point of interaction. The system registers the touch coordinates. The system executes the corresponding action at those coordinates.

This direct-touch approach functions adequately for simple operations. Tapping large buttons presents minimal difficulty. Scrolling through content lists operates reliably. Activating menu items succeeds with reasonable consistency.

However, direct-touch systems encounter substantial limitations when precision becomes necessary. The human finger typically measures 8-10 millimeters in diameter. This contact area covers hundreds of pixels on modern high-resolution displays. The system must infer the intended interaction point from the centroid of this contact area.

The finger simultaneously obscures the target region during contact. A user cannot observe the exact position where the system will register the input. This occlusion becomes particularly problematic for small interface elements. Text cursor positioning between individual characters becomes extremely difficult. Selecting specific nodes in vector graphics requires multiple attempts. Sampling precise color values in image editing applications proves unreliable.

Conventional systems also struggle with unintended activation. Light contact while repositioning the hand triggers unwanted inputs. Natural hand tremor causes cursor drift during attempted stationary contact. The system cannot distinguish between deliberate movement and involuntary motion.

Traditional touchscreen interfaces lack an intermediate engagement state. Desktop pointer systems provide hover functionality. A cursor can be positioned over an element without triggering activation. This allows preview of potential actions. Users can verify target selection before committing to an operation. Touchscreens provide only binary states of contact or non-contact.

Professional applications requiring fine-grained control remain largely inaccessible through finger-based touch input alone. Graphic designers cannot manipulate Bezier curve control points with sufficient accuracy. CAD operators cannot specify coordinates with necessary precision. Photo editors cannot refine selection masks at pixel level. Text editors cannot position cursors reliably within dense character sequences.

Current solutions to these precision limitations typically involve external input devices. Active styluses provide improved accuracy but require separate hardware. These accessories must be purchased separately. They require charging or battery replacement. They can be misplaced or forgotten. Passive styluses offer poor precision and lack pressure sensitivity. External mice and trackpads defeat the portability advantages of touchscreen devices.

Some systems implement magnification tools to improve target visibility. These tools interrupt workflow by requiring mode activation. They reduce the visible context area. They consume additional screen space for magnification controls. They do not address the fundamental occlusion problem.

Other approaches expand the effective target area of small interface elements. This sacrifices screen space efficiency. Dense professional interfaces cannot accommodate enlarged targets. Target expansion creates ambiguity when multiple elements occupy adjacent positions.

Certain implementations provide indirect manipulation modes. A screen region functions as a trackpad for cursor control. This requires mental translation between input location and cursor position. The direct manipulation metaphor is broken. Cognitive load increases substantially. These modes require explicit activation and deactivation.

Conventional systems also lack graduated feedback mechanisms. Visual indicators typically operate in binary states. An element is either highlighted or not highlighted. The system provides no indication of proximity to activation thresholds. Users receive no feedback about building interaction tension. The relationship between input magnitude and system response remains opaque.

However, these conventional systems present significant limitations for precision work. The user's finger obscures the target element during contact. This occlusion prevents the user from seeing the exact cursor position. The problem becomes particularly acute for tasks requiring pixel-level accuracy.

Direct-touch interfaces are prone to unintended cursor shifts. Even slight finger movements during initial contact cause the cursor to jump to unintended positions. Users attempting precise manipulations experience frustration from these accidental movements.

Traditional touchscreen interfaces lack an intermediate interaction state. Mouse-based interfaces support hovering over elements to preview actions. Users can reveal additional information without committing to a selection. Touchscreen users must commit to touching an element to interact with it. This eliminates the ability to inspect or preview before acting.

Tasks requiring fine-grained control present substantial challenges. Graphic design applications demand precise node manipulation. CAD work requires exact coordinate specification. Text editing necessitates accurate cursor placement between characters. Vector graphics editing involves detailed path adjustments. Photo editing requires pixel-level selection accuracy. These tasks prove extremely difficult on touchscreens without external input devices.

Users resort to external input devices to overcome these limitations. Styluses provide improved precision but require additional purchase. Mice offer familiar control but defeat the purpose of a self-contained touchscreen interface. Trackpads add complexity and cost. These accessories must be carried separately. The need for external tools undermines the fundamental advantage of touchscreen devices.

Desktop environments support complex interaction patterns. Click-and-drag operations enable sophisticated manipulations. Hover-then-click workflows allow deliberate action sequences. Multi-step selection processes facilitate complex editing tasks. Touchscreen interfaces traditionally lack these nuanced workflows. This limitation restricts their utility for professional applications. Power users find touchscreen interfaces inadequate for advanced tasks.

There exists a need for a touchscreen input method that eliminates finger occlusion while maintaining direct interaction. The method should prevent accidental cursor movements through deliberate engagement mechanisms. Visual feedback should communicate system state to the user. The system should enable preview of actions before commitment. Complex multi-stage workflows should be supported without external devices. The solution should apply broadly across applications requiring precision input.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

A method for precision touch input on a touchscreen device may detect an initial touch at a first location on a touchscreen display. The first location may be stored as a starting point. Movement of the touch from the first location to a current location may be detected. A tension value may be computed based on a distance between the starting point and the current location. A visual indicator may be rendered that extends between the starting point and the current location. At least one visual property of the visual indicator may vary as a function of the tension value. The tension value may be compared to a predefined threshold. While the tension value is below the predefined threshold, a cursor may be maintained at the starting point. When the tension value meets or exceeds the predefined threshold, the visual indicator may be modified to indicate an engaged state. Movement of the cursor may be enabled based on the current location with an offset from the current location such that the cursor is visually separated from the touch.

A system for precision touch input may comprise a touchscreen display configured to detect touch input. The system may comprise a processor. The system may comprise a memory storing instructions that, when executed by the processor, cause the system to detect an initial touch at a first location on the touchscreen display. The first location may be stored as a starting point. Movement of the touch from the first location to a current location may be detected. A tension value may be computed based on a distance between the starting point and the current location. A visual indicator may be rendered that extends between the starting point and the current location. At least one visual property of the visual indicator may vary as a function of the tension value. The tension value may be compared to a predefined threshold. While the tension value is below the predefined threshold, a cursor may be maintained at the starting point. When the tension value meets or exceeds the predefined threshold, the visual indicator may be modified to indicate an engaged state. Movement of the cursor may be enabled based on the current location with an offset from the current location such that the cursor is visually separated from the touch.

A non-transitory computer-readable medium may store instructions that, when executed by one or more processors of a computing device having a touchscreen display, cause the computing device to perform operations. The operations may comprise detecting an initial touch at a first location on the touchscreen display. The first location may be stored as a starting point. Movement of the touch from the first location to a current location may be detected. A tension value may be computed based on a distance between the starting point and the current location. A visual indicator may be rendered that extends between the starting point and the current location. At least one visual property of the visual indicator may vary as a function of the tension value. The tension value may be compared to a predefined threshold. While the tension value is below the predefined threshold, a cursor may be maintained at the starting point. When the tension value meets or exceeds the predefined threshold, the visual indicator may be modified to indicate an engaged state. Movement of the cursor may be enabled based on the current location with an offset from the current location such that the cursor is visually separated from the touch.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 shows a block diagram of a touchscreen device comprising a tension-based precision touch input mechanism, according to the present disclosure.

FIG. 2 shows a flowchart depicting a method for using the tension-based precision touch input mechanism.

FIG. 3 shows a first stage of using the tension-based precision touch input mechanism, including selecting an area of interest as a starting point.

FIG. 4 shows a second stage of using the tension-based precision touch input mechanism, including beginning to drag away from the starting point.

FIG. 5 shows a third stage of using the tension-based precision touch input mechanism, including rendering an indicator of the tension between the starting point and the current location.

FIG. 6 shows a fourth stage of operating the tension-based precision touch input mechanism, including moving the cursor at an offset tot eh location of the touch interaction.

FIG. 7 shows a block diagram of a computing device for use in facilitating operation of the tension-based precision touch input mechanism.

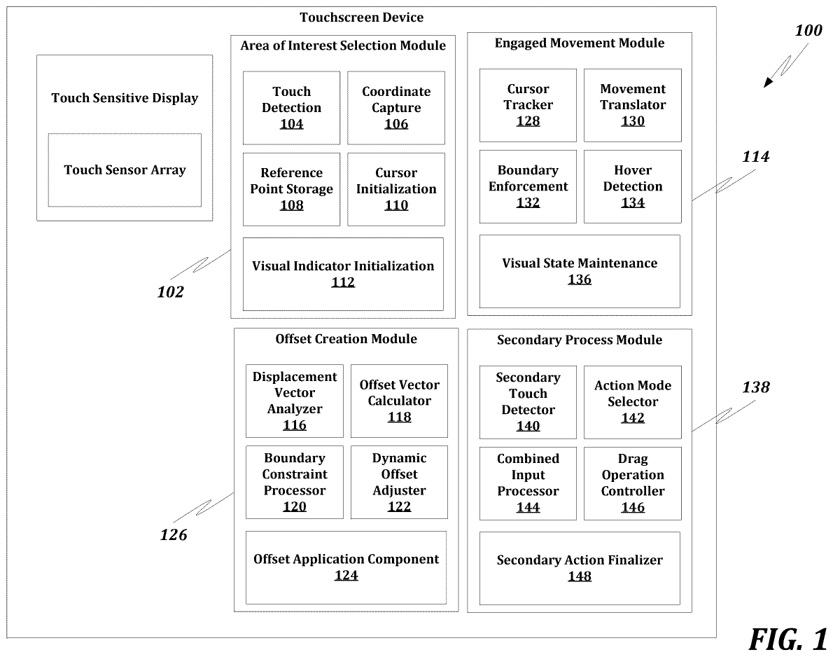

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely to provide a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of the term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

Touchscreen devices have become ubiquitous computing platforms for a wide range of applications. However, touchscreen interfaces face fundamental limitations that restrict their utility for precision tasks. The primary technical problem addressed by the present disclosure relates to the inherent imprecision and occlusion challenges associated with direct finger-based touch input on touchscreen displays.

A first technical problem may be finger occlusion. When a user touches a touchscreen display with a finger, the finger itself blocks the user's view of the target area. This occlusion may be particularly problematic when attempting to interact with small user interface elements or when performing tasks requiring pixel-level precision. The finger contact area may span multiple pixels, making it difficult for the user to see exactly where the touch is registered. This visual obstruction may force users to adopt awkward hand positions or repeatedly lift and reposition their finger to verify cursor placement.

A second technical problem may be imprecise target selection. The contact area of a human finger on a touchscreen may typically measure approximately eight to ten millimeters in diameter. This contact area may encompass dozens or hundreds of pixels on modern high-resolution displays. When a user attempts to select a small target such as a text insertion point, a node in a graphic design application, or a precise coordinate on a map, the system may face ambiguity in determining the user's intended target location within the larger contact area. Conventional touchscreen interfaces may register the touch at the centroid of the contact area, but this location may not correspond to the user's actual intended target.

A third technical problem may be limited interaction vocabulary. Mouse-based interfaces may support complex multi-stage interactions such as hover-then-click, click-and-drag, and right-click context menus. Touchscreen interfaces may offer a more limited set of gestures, primarily consisting of tap, swipe, and pinch. This reduced interaction vocabulary may make it difficult to implement sophisticated applications that require nuanced input control.

A fourth technical problem may be application limitations. The precision limitations of conventional touchscreen input may restrict the types of applications that can be effectively implemented on touchscreen devices. Professional-grade graphic design applications, detailed technical drawing tools, precision text editing interfaces, and other applications requiring fine-grained control may be impractical or impossible to use effectively with conventional touch input.

These technical problems (along with others) may manifest across varying scenarios and use cases. In a graphic design scenario, a user may attempt to manipulate edit nodes in a vector graphics application. The user may need to select a specific node among several closely-spaced nodes and then drag that node to a precise new location. With conventional touch input, the user's finger may occlude the nodes, making it difficult to see which node is being selected. The large finger contact area may make it ambiguous which node the system should select. Once a node is selected, dragging it to a precise location may be difficult because the finger continues to block the view of the target position.

In a text editing scenario, a user may attempt to position a text cursor at a specific character position within a line of text. The finger contact area may span multiple characters, making it unclear where the cursor will be placed. The user may need to repeatedly tap and adjust the cursor position, interrupting the writing workflow. Small text sizes may exacerbate this problem, as the target insertion point may be only a few pixels wide.

In a mapping application scenario, a user may attempt to place a pin at a precise geographic location. The finger may occlude the map area, preventing the user from seeing exactly where the pin will be placed. The user may need to zoom in significantly to achieve adequate precision, but this zooming may cause loss of geographic context. After placing the pin, the user may need to zoom out to verify the placement, then potentially zoom back in to make adjustments.

A diverse array of scenarios may share common characteristics. Each scenario may require pixel-level or near-pixel-level precision for user input. Each scenario may involve small target elements that may be difficult to select with finger-based input. Each scenario may suffer from finger occlusion that blocks the user's view of the target area. Each scenario may benefit from hover-like interactions that allow inspection before commitment. Each scenario may involve multi-stage interactions that may be difficult to perform with conventional touch input.

The primary use case that may serve as the focus for the present disclosure may be graphic design applications, particularly applications involving manipulation of edit nodes in vector graphics. In this use case, a user may work with a vector graphics editor on a touchscreen tablet device. The editor may display a vector path composed of multiple connected segments. Each segment may be defined by control points or edit nodes that determine the shape of the path. The user may need to select a specific edit node and drag it to a new position to modify the path shape.

With conventional touch input, this task may present multiple challenges. When the user touches the screen near an edit node, the finger may occlude the node and surrounding path segments. The system may have difficulty determining which node the user intends to select if multiple nodes are nearby. Once a node is selected, dragging it to a precise new location may be difficult because the finger continues to block the view. The user may need to repeatedly adjust the node position, lifting the finger to see the result, then touching again to make further adjustments. This iterative process may be time-consuming and frustrating.

The technical problems described above may limit the utility of touchscreen devices for professional and precision-oriented applications. Users may be forced to choose between the portability and convenience of touchscreen devices and the precision and control of traditional desktop computing with mouse input. The present disclosure may address these technical problems through a tension-based precision touch input mechanism that may enable pixel-level control while eliminating finger occlusion and preventing accidental activation.

The present disclosure may provide a tension-based precision touch input mechanism that may address the technical limitations of conventional direct-touch interfaces. The mechanism may enable pixel-level cursor control on touchscreen devices without requiring external input hardware such as styluses or mice. The solution may eliminate finger occlusion challenges while preventing accidental cursor activation through a deliberate, threshold-based engagement paradigm.

The tension-based mechanism may operate through a multi-stage interaction model. Upon initial touch contact, the system may record a reference point and may fix a cursor position at that reference point. As the user's finger may move away from the reference point while maintaining contact, the system may calculate a displacement distance and may compute a corresponding tension magnitude. A visual indicator may extend from the reference point to the current finger position, and one or more visual properties of the indicator may be dynamically modified to reflect the current tension level. The cursor may remain locked at the reference point until the tension magnitude may exceed a predefined threshold. Once the threshold may be exceeded, the cursor may unlock and may begin to move in correspondence with finger movement, but with a calculated offset that may position the cursor away from the finger contact point to prevent occlusion.

The offset cursor positioning may enable the user to maintain an unobstructed view of the target area throughout the interaction. The user may perform fine-grained manipulations with pixel-level precision while the finger may not block the view of the cursor or the target elements. The tension threshold requirement may ensure that cursor activation may be deliberate and intentional, thereby preventing accidental cursor movements that may plague conventional direct-touch interfaces. The visual feedback mechanism may provide real-time communication of system state, allowing the user to understand when the cursor may be locked versus unlocked and how much additional finger movement may be required to achieve threshold.

The solution may further provide hover-like interaction capabilities that may be absent in traditional touchscreen interfaces. After the cursor may be unlocked and actively moving, the user may pause finger movement to inspect interface elements or preview action outcomes without committing to a final action. This hover state may enable workflows similar to mouse-based desktop interactions where users may explore options before making selections. Additionally, the system may support multi-touch secondary actions wherein a second finger contact may initiate additional operations such as drag-and-drop, selection locking, or context-specific actions while the primary finger may maintain cursor control.

The functional approach to visual feedback may provide broad applicability and design-around resistance. Rather than relying on a single specific visual change, the system may modify one or more visual properties selected from pattern, color, opacity, thickness, and shape. This multi-dimensional feedback approach may ensure that the tension state may be communicated effectively across different interface contexts and user preferences. The threshold value may be configurable, either through user settings or through dynamic adjustment based on application context, task type, or learned user behavior patterns. This configurability may allow the system to adapt to different precision requirements across various use cases, from coarse navigation tasks to fine-grained graphic design operations.

The present disclosure includes many aspects and features. Moreover, while many aspects and features relate to, and are described in, the context of a tension-based precision touch input mechanism, embodiments of the present disclosure are not limited to use only in this context.

### I. Platform Overview

This overview is provided to introduce a selection of concepts in a simplified form that are further described below. This overview is not intended to identify key features or essential features of the claimed subject matter. Nor is this overview intended to be used to limit the claimed subject matter's scope.

The present disclosure may provide a tension-based precision touch input mechanism 100 for touchscreen devices. The mechanism may address fundamental limitations of conventional direct-touch interfaces where finger occlusion and imprecise targeting may restrict the utility of touchscreen devices for tasks requiring fine-grained control. The disclosed system may enable pixel-level cursor manipulation without requiring external input hardware such as styluses or mice.

The mechanism may operate through a multi-stage interaction paradigm. Upon initial touch contact, the system may record a reference point and may establish a cursor position at that reference point. The cursor may remain locked at the reference point while the user's finger may move across the screen surface. As the finger may move away from the reference point, the system may calculate a displacement distance and may compute a corresponding tension magnitude. A visual indicator may extend from the reference point to the current finger position. One or more visual properties of the indicator may be dynamically modified to reflect the current tension level.

The cursor may remain locked at the reference point until the tension magnitude may exceed a predefined threshold. Once the threshold may be exceeded, the cursor may unlock and may begin to move in correspondence with finger movement. The cursor may be positioned with a calculated offset from the finger contact point. This offset may prevent the finger from occluding the cursor and may enable the user to maintain an unobstructed view of the target area throughout the interaction. The user may perform fine-grained manipulations with pixel-level precision while the finger may not block the view of the cursor or the target elements.

The tension threshold requirement may ensure that cursor activation may be deliberate and intentional. Accidental cursor movements that may plague conventional direct-touch interfaces may be prevented. The visual feedback mechanism may provide real-time communication of system state. The user may understand when the cursor may be locked versus unlocked. The user may understand how much additional finger movement may be required to achieve threshold. The visual feedback may employ functional modifications to one or more visual properties selected from pattern, color, opacity, thickness, and shape. This multi-dimensional feedback approach may ensure that the tension state may be communicated effectively across different interface contexts and user preferences.

After the cursor may be unlocked and actively moving, the user may pause finger movement to inspect interface elements or preview action outcomes without committing to a final action. This hover state may enable workflows similar to mouse-based desktop interactions where users may explore options before making selections. The system may support multi-touch secondary actions wherein a second finger contact may initiate additional operations such as drag-and-drop, selection locking, or context-specific actions while the primary finger may maintain cursor control. The threshold value may be configurable through user settings or through dynamic adjustment based on application context, task type, or learned user behavior patterns.

Embodiments of the present disclosure may comprise methods, systems, and a computer readable medium comprising, but not limited to, at least one of the following:
A. An Area of Interest Selection Module
B. An Offset Creation Module
C. An Engaged Movement Module
D. A Secondary Process Module

Details with regards to each module are provided below. Although modules are disclosed with specific functionality, it should be understood that functionality may be shared between modules, with some functions split between modules, while other functions duplicated by the modules. Furthermore, the name of each module should not be construed as limiting upon the functionality of the module. Moreover, each component disclosed within each module can be considered independently, without the context of the other components within the same module or different modules. Each component may contain functionality defined in other portions of this specification. Each component disclosed for one module may be mixed with the functionality of other modules. In the present disclosure, each component can be claimed on its own and/or interchangeably with other components of other modules.

The following depicts an example of a method of a plurality of methods that may be performed by at least one of the aforementioned modules, or components thereof. Various hardware components may be used at the various stages of the operations disclosed with reference to each module. For example, although methods may be described to be performed by a single computing device, it should be understood that, in some embodiments, different operations may be performed by different networked elements in operative communication with the computing device. For example, at least one computing device 700 may be employed in the performance of some or all of the stages disclosed with regard to the methods. Similarly, an apparatus may be employed in the performance of some or all of the stages of the methods. As such, the apparatus may comprise at least those architectural components as found in computing device 700.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in orders that differ from the ones disclosed below. Moreover, various stages may be added or removed without altering or departing from the fundamental scope of the depicted methods and systems disclosed herein.

Consistent with embodiments of the present disclosure, a method may be performed by at least one of the modules disclosed herein. The method may be embodied as, for example, but not limited to, computer instructions which, when executed, perform the method. The method may comprise the following stages:
detecting an initial touch at a first location on a touchscreen display;
storing the first location as a starting point;
detecting movement of the touch from the first location to a current location;
computing a tension value based on a distance between the starting point and the current location;
rendering a visual indicator that extends between the starting point and the current location, wherein at least one visual property of the visual indicator varies as a function of the tension value;
comparing the tension value to a threshold;
while the tension value is below the threshold, maintaining a cursor at the starting point; and
when the tension value meets or exceeds the threshold, modifying the visual indicator to indicate an engaged state and enabling movement of the cursor based on the current location with an offset from the current location such that the cursor is visually separated from the touch.

Although the aforementioned method has been described to be performed by the platform 100, it should be understood that computing device 700 may be used to perform the various stages of the method. Furthermore, in some embodiments, different operations may be performed by different networked elements in operative communication with computing device 700. For example, a plurality of computing devices may be employed in the performance of some or all of the stages in the aforementioned method. Moreover, a plurality of computing devices may be configured much like a single computing device 700. Similarly, an apparatus may be employed in the performance of some or all stages in the method. The apparatus may also be configured much like computing device 700.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Platform Configuration

The tension-based precision touch input mechanism may represent a fundamental advancement in touchscreen interaction paradigms. The mechanism may address longstanding limitations that may have constrained the utility of direct-touch interfaces for precision-oriented tasks. The disclosed system may enable users to perform pixel-level cursor manipulations on touchscreen devices without requiring external input hardware such as styluses or mice. The mechanism may eliminate finger occlusion challenges while providing deliberate, threshold-based cursor activation that may prevent accidental input.

The operational paradigm may comprise multiple integrated stages that may work in concert to transform imprecise direct-touch input into precision-controlled cursor manipulation. Upon initial touch contact with the display surface, the system may record a reference point and may establish a cursor position at that reference point. The cursor may remain locked at the reference point while the user's finger may move across the screen surface. As the finger may move away from the reference point, the system may calculate a displacement distance and may compute a corresponding tension magnitude. A visual indicator may extend from the reference point to the current finger position. One or more visual properties of the indicator may be dynamically modified to reflect the current tension level. The cursor may remain locked at the reference point until the tension magnitude may exceed a predefined threshold.

Once the threshold may be exceeded, the cursor may unlock and may begin to move in correspondence with finger movement. The cursor may be positioned with a calculated offset from the finger contact point. This offset may prevent the finger from occluding the cursor and may enable the user to maintain an unobstructed view of the target area throughout the interaction. The user may perform fine-grained manipulations with pixel-level precision while the finger may not block the view of the cursor or the target elements. The tension threshold requirement may ensure that cursor activation may be deliberate and intentional. Accidental cursor movements that may plague conventional direct-touch interfaces may be prevented through this threshold-based engagement mechanism.

The visual feedback mechanism may provide real-time communication of system state to the user. The user may understand when the cursor may be locked versus unlocked based on the visual indicator appearance. The user may understand how much additional finger movement may be required to achieve threshold based on the dynamic visual property changes. The visual feedback may employ functional modifications to one or more visual properties selected from pattern, color, opacity, thickness, and shape. This multi-dimensional feedback approach may ensure that the tension state may be communicated effectively across different interface contexts and user preferences. The functional approach to visual feedback may provide broad applicability and may resist design-around attempts by competitors.

After the cursor may be unlocked and actively moving, the user may pause finger movement to inspect interface elements or preview action outcomes without committing to a final action. This hover state may enable workflows similar to mouse-based desktop interactions where users may explore options before making selections. The system may support multi-touch secondary actions wherein a second finger contact may initiate additional operations such as drag-and-drop, selection locking, or context-specific actions while the primary finger may maintain cursor control. The threshold value may be configurable through user settings or through dynamic adjustment based on application context, task type, or learned user behavior patterns. This configurability may allow the system to adapt to different precision requirements across various use cases, from coarse navigation tasks to fine-grained graphic design operations.

Application-specific implementations may provide tailored functionality across various domains. In text editing applications, the system may enable precise cursor positioning between characters by snapping to character boundaries and providing sub-pixel positioning accuracy. Graphic design applications may utilize tension-based input for node manipulation in vector graphics, allowing precise control over Bezier curve handles and anchor points. Mapping applications may implement tension-based pin placement with coordinate precision and route drawing capabilities that follow road networks. CAD applications may integrate tension-based input for precise measurement tools, dimension placement, and technical drawing operations. The system may provide application programming interfaces (APIs) that allow third-party developers to customize tension parameters and visual feedback for their specific use cases.

Hardware platform variations may accommodate different device types and input mechanisms. Smartphone implementations may optimize for single-handed operation with adjusted offset calculations and thumb-friendly interaction zones. Tablet configurations may support multi-user scenarios with simultaneous tension-based inputs from multiple users. Large display adaptations may scale visual indicators and adjust sensitivity for viewing distances and arm reach limitations. Stylus input integration may combine pressure sensitivity with tension-based positioning for enhanced precision in drawing and annotation tasks. Pressure-sensitive screen implementations may incorporate force feedback as an additional dimension in tension calculations. Virtual and augmented reality environments may adapt tension-based input for 3D spatial interactions with depth-aware cursor positioning.

Calibration and personalization systems may provide user setup and adaptive learning capabilities. Initial calibration workflows may guide users through sensitivity adjustment exercises to determine optimal threshold values and offset distances. Per-user preference profiles may store individual settings including preferred visual indicator styles, feedback modes, and application-specific configurations. Adaptive learning algorithms may continuously refine user models based on interaction success rates and behavioral patterns. Context-aware configuration management may automatically switch between different setting profiles based on detected usage scenarios such as mobile versus desktop use, or different applications. The system may provide manual override controls that allow users to temporarily adjust settings without affecting their learned profiles.

Error recovery and robustness mechanisms may ensure reliable operation under various conditions. Palm rejection algorithms may analyze contact geometry, pressure distribution, and simultaneous touch patterns to distinguish between intentional finger input and accidental palm contact. Accidental touch filtering may implement temporal analysis to identify and discard brief, unintentional touches that do not represent deliberate user input. Gesture cancellation methods may provide escape mechanisms such as rapid movement to screen edges or specific gesture patterns that abort tension-based interactions. Recovery from interrupted interactions may include state preservation during system interruptions, automatic resumption of partially completed gestures, and graceful degradation when hardware resources are constrained. The system may implement timeout mechanisms that automatically reset to inactive state after periods of inactivity.

Performance optimization techniques may ensure responsive operation across various hardware configurations. Real-time processing optimizations may include efficient algorithms for distance calculations, optimized rendering pipelines for visual indicators, and predictive caching of frequently accessed interface elements. Battery usage minimization may be achieved through selective sensor activation, adaptive refresh rates based on interaction intensity, and power-efficient graphics rendering techniques. Frame rate maintenance may utilize variable update frequencies, prioritized rendering queues, and dynamic quality adjustment based on system load. Resource management strategies may include memory pooling for visual effects, background processing for machine learning updates, and intelligent scheduling of computational tasks to maintain user interface responsiveness.

The platform operation may be governed by a formal state machine that defines system behavior and transition logic. The inactive state may represent the default condition where no touch input is detected and the system monitors for initial touch events. The locked state may occur when initial touch is detected but tension threshold has not been reached, maintaining cursor position at the starting point. The engaged state may be entered when tension exceeds the threshold, enabling cursor movement with offset positioning. The hover state may provide preview functionality when touch movement pauses while in engaged mode. The secondary state may handle multi-touch scenarios and additional gesture recognition. State transitions may be triggered by specific conditions including touch detection, tension threshold comparison, movement cessation, and touch termination. The system may implement state persistence mechanisms that maintain current state during brief system interruptions and provide recovery mechanisms that restore appropriate states after unexpected terminations.

Integration with operating system services may provide seamless interaction with platform-level functionality. Accessibility service integration may register with system accessibility frameworks to provide touch input information to screen readers and other assistive technologies. System gesture recognition coordination may communicate with OS-level gesture handlers to prevent conflicts between application-specific tension gestures and system navigation gestures. Notification handling may implement appropriate responses to system notifications that may interrupt or modify touch input processing. Power management integration may adjust processing intensity and update frequencies based on battery level and power saving modes. Background and foreground state management may modify system behavior when applications transition between active and inactive states, including state preservation and resource cleanup. The system may register for system-level events including device rotation, display configuration changes, and accessibility setting modifications.

Developer APIs and integration interfaces may enable third-party applications to leverage tension-based input functionality. Event callback mechanisms may provide registration interfaces for touch events, tension state changes, and cursor position updates with customizable event filtering and priority handling. Configuration APIs may allow applications to programmatically adjust tension thresholds, offset parameters, and visual indicator properties to match application-specific requirements. Custom visual indicator registration may enable developers to define application-specific indicator graphics, animations, and styling that integrate with the core tension-based input system. Plugin architectures may support modular extensions that add specialized functionality for specific application domains or interaction patterns. SDK components may include development libraries, documentation, code examples, and debugging tools that facilitate integration of tension-based input into third-party applications. The system may provide versioned APIs with backwards compatibility guarantees and migration guides for API updates.

Accordingly, embodiments of the present disclosure provide a software and hardware platform comprised of a distributed set of computing elements, including, but not limited to:

### A. an Area of Interest Selection Module

The tension-based precision touch input mechanism 100 may include an area of interest module 102. The area of interest module 102 may include hardware and/or software configured to establish an initial reference point for tension-based cursor control. The area of interest module 102 may comprise a touch detection component 104, a coordinate capture component 106, a reference point storage component 108, a cursor initialization component 110, and a visual indicator initialization component 112.

The touch detection component 104 may be configured to monitor the touch-sensitive display for initial contact events. The touch detection component 104 may interface with the touch sensor array to detect when a user's finger first makes contact with the display surface. The touch detection component 104 may generate a touch-down event signal upon detecting initial contact. The touch detection component 104 may distinguish initial contact from ongoing contact or multi-touch scenarios. The touch detection component 104 may filter spurious touch events to ensure reliable detection.

Touch event processing and filtering mechanisms may handle low-level input signal management to ensure reliable operation. The system may implement touch event queuing with priority-based processing to maintain responsiveness during high-frequency input. Debouncing algorithms may filter rapid successive touch events that occur within configurable time windows to prevent spurious activations. Noise filtering for capacitive sensors may employ digital signal processing techniques including low-pass filters and median filtering to reduce electromagnetic interference effects. Multi-touch disambiguation may utilize spatial and temporal analysis to separate overlapping or closely spaced touch points. The system may implement touch rejection algorithms that temporarily disable input processing when palm contact is detected, using contact area analysis and pressure distribution patterns to distinguish between intentional finger touches and accidental palm contact.

The coordinate capture component 106 may be configured to record the spatial coordinates of the initial touch event. The coordinate capture component 106 may receive touch position data from the touch detection component 104. The coordinate capture component 106 may normalize the raw sensor coordinates to display pixel coordinates. The coordinate capture component 106 may timestamp the coordinate data for temporal analysis. The coordinate capture component 106 may associate the coordinates with a unique touch identifier for multi-touch tracking.

Coordinate system transformations may provide mathematical mapping between different spatial reference frames. Screen-to-world coordinate mapping may convert pixel coordinates to application-specific coordinate systems, accounting for scaling factors and origin offsets. Rotation transformations may handle device orientation changes by applying rotation matrices to maintain consistent interaction behavior across portrait and landscape modes. Scaling transformations may adjust coordinate values based on display density and zoom levels to ensure consistent physical interaction distances. Viewport transformations may map between local view coordinates and global document coordinates in applications with scrollable or zoomable content. The system may implement coordinate system normalization that provides device-independent coordinate values, enabling consistent behavior across different screen sizes and resolutions. Transformation matrices may be cached and updated only when display configuration changes to optimize computational performance.

The reference point storage component 108 may be configured to preserve the initial touch coordinates as a reference point for subsequent tension calculations. The reference point storage component 108 may allocate memory space for storing the reference point coordinates. The reference point storage component 108 may maintain the reference point data throughout the duration of the touch interaction. The reference point storage component 108 may associate the reference point with the corresponding touch identifier. The reference point storage component 108 may provide access to the stored reference point for other system components.

The cursor initialization component 110 may be configured to establish an initial cursor position corresponding to the reference point. The cursor initialization component 110 may set the cursor coordinates to match the reference point coordinates. The cursor initialization component 110 may render the cursor graphic at the initial position. The cursor initialization component 110 may set the cursor state to a locked configuration. The cursor initialization component 110 may prepare the cursor for subsequent state transitions.

The visual indicator initialization component 112 may be configured to create an initial visual tension indicator at the reference point. The visual indicator initialization component 112 may generate a graphical element representing the tension indicator. The visual indicator initialization component 112 may set initial visual properties corresponding to zero or minimal tension. The visual indicator initialization component 112 may position the indicator at the reference point coordinates. The visual indicator initialization component 112 may register the indicator with the rendering pipeline for subsequent updates.

The area of interest selection module 102 may implement dynamic threshold adaptation mechanisms that automatically adjust sensitivity based on user behavior and context. Machine learning algorithms may analyze historical interaction patterns to optimize threshold values for individual users. The system may detect application context through API calls or window focus detection to apply context-specific threshold configurations. Error rate analysis may track unsuccessful interactions and adjust thresholds to minimize false activations or missed engagements. Performance metrics such as task completion time and user satisfaction scores may inform adaptive threshold algorithms. The system may maintain separate threshold profiles for different applications, user postures, and environmental conditions.

### B. An Offset Creation Module

The tension-based precision touch input mechanism 100 may include an offset creation module 114. The offset creation module 114 may include hardware and/or software configured to calculate and maintain a spatial offset between the user's finger position and the cursor position once the tension threshold may be exceeded. The offset creation module 114 may comprise a displacement vector analyzer 116, an offset vector calculator 118, a boundary constraint processor 120, a dynamic offset adjuster 122, and an offset application component 124.

The displacement vector analyzer 116 may be configured to compute the directional relationship between the reference point and the current finger position. The displacement vector analyzer 116 may receive the reference point coordinates from the reference point storage component 108. The displacement vector analyzer 116 may receive the current finger position coordinates from the coordinate capture component 106. The displacement vector analyzer 116 may calculate the horizontal displacement component as the difference between the current x-coordinate and the reference x-coordinate. The displacement vector analyzer 116 may calculate the vertical displacement component as the difference between the current y-coordinate and the reference y-coordinate. The displacement vector analyzer 116 may determine the angle of the displacement vector relative to a horizontal axis. The displacement vector analyzer 116 may normalize the displacement vector to unit length for directional analysis. The displacement vector analyzer 116 may provide the displacement vector components to the offset vector calculator 118.

The offset vector calculator 118 may be configured to determine the magnitude and direction of the cursor offset relative to the finger position. The offset vector calculator 118 may receive the displacement vector from the displacement vector analyzer 116. The offset vector calculator 118 may apply a predefined offset distance value stored in configuration memory. The offset vector calculator 118 may calculate the offset vector perpendicular to the displacement vector to position the cursor away from the finger. The offset vector calculator 118 may alternatively calculate the offset vector in a fixed direction relative to the display orientation. The offset vector calculator 118 may scale the offset magnitude based on the current tension value. The offset vector calculator 118 may apply a directional bias to position the cursor above the finger or to the side of the finger. The offset vector calculator 118 may compute the offset vector components in display coordinate space. The offset vector calculator 118 may provide the calculated offset vector to the boundary constraint processor 120.

The boundary constraint processor 120 may be configured to ensure that the offset cursor position may remain within the valid display area. The boundary constraint processor 120 may receive the calculated offset vector from the offset vector calculator 118. The boundary constraint processor 120 may receive the current finger position coordinates from the coordinate capture component 106. The boundary constraint processor 120 may compute a preliminary cursor position by adding the offset vector to the finger position. The boundary constraint processor 120 may compare the preliminary cursor position against the display boundaries. The boundary constraint processor 120 may detect when the preliminary cursor position may exceed the left boundary of the display. The boundary constraint processor 120 may detect when the preliminary cursor position may exceed the right boundary of the display. The boundary constraint processor 120 may detect when the preliminary cursor position may exceed the top boundary of the display. The boundary constraint processor 120 may detect when the preliminary cursor position may exceed the bottom boundary of the display. The boundary constraint processor 120 may adjust the offset vector to constrain the cursor position within the display boundaries. The boundary constraint processor 120 may provide the constrained offset vector to the dynamic offset adjuster 122.

The dynamic offset adjuster 122 may be configured to modify the offset vector in response to changing interaction conditions. The dynamic offset adjuster 122 may receive the constrained offset vector from the boundary constraint processor 120. The dynamic offset adjuster 122 may monitor the proximity of the cursor to display edges. The dynamic offset adjuster 122 may reduce the offset magnitude when the cursor may approach a display edge. The dynamic offset adjuster 122 may rotate the offset direction when the cursor may approach a corner region of the display. The dynamic offset adjuster 122 may adjust the offset based on the current application context. The dynamic offset adjuster 122 may increase the offset magnitude for applications requiring greater precision. The dynamic offset adjuster 122 may decrease the offset magnitude for applications with larger target elements. The dynamic offset adjuster 122 may modify the offset direction based on the user's hand position relative to the display. The dynamic offset adjuster 122 may apply smoothing to offset adjustments to prevent abrupt cursor movements. The dynamic offset adjuster 122 may provide the adjusted offset vector to the offset application component 124.

The offset application component 124 may be configured to apply the calculated offset to determine the final cursor position. The offset application component 124 may receive the adjusted offset vector from the dynamic offset adjuster 122. The offset application component 124 may receive the current finger position from the coordinate capture component 106. The offset application component 124 may add the offset vector components to the finger position coordinates. The offset application component 124 may compute the final cursor x-coordinate as the sum of the finger x-coordinate and the offset x-component. The offset application component 124 may compute the final cursor y-coordinate as the sum of the finger y-coordinate and the offset y-component. The offset application component 124 may store the final cursor position in a cursor position register. The offset application component 124 may provide the final cursor position to the cursor rendering module for display. The offset application component 124 may generate cursor position update events for transmission to the application layer. The offset application component 124 may maintain a history of recent cursor positions for motion analysis. The offset application component 124 may calculate cursor velocity based on position changes over time.

### C. An Engaged Movement Module

The tension-based precision touch input mechanism 100 may include an engaged movement module 126. The engaged movement module 126 may include hardware and/or software configured to manage cursor behavior and user interaction after the tension threshold may be exceeded and the cursor may transition to an unlocked state. The engaged movement module 126 may comprise a cursor tracking component 128, a movement translation component 130, a boundary enforcement component 132, a hover detection component 134, and a visual state maintenance component 136.

The cursor tracking component 128 may be configured to monitor the cursor position during the engaged movement phase. The cursor tracking component 128 may receive the current cursor coordinates from the offset application component 124. The cursor tracking component 128 may maintain a position history buffer storing recent cursor positions. The cursor tracking component 128 may calculate cursor velocity based on position changes over time. The cursor tracking component 128 may determine cursor acceleration by analyzing velocity changes. The cursor tracking component 128 may detect cursor movement patterns for gesture recognition. The cursor tracking component 128 may provide cursor position data to the application layer. The cursor tracking component 128 may generate cursor position update events at a predetermined frequency. The cursor tracking component 128 may timestamp each cursor position for temporal analysis. The cursor tracking component 128 may associate cursor positions with corresponding finger positions for correlation analysis.

The movement translation component 130 may be configured to convert finger movements into corresponding cursor movements while maintaining the offset relationship. The movement translation component 130 may receive current finger position updates from the coordinate capture component 106. The movement translation component 130 may receive the offset vector from the offset application component 124. The movement translation component 130 may calculate the new cursor position by adding the offset vector to the current finger position. The movement translation component 130 may apply motion smoothing algorithms to reduce jitter in cursor movement. The movement translation component 130 may implement velocity-based cursor acceleration for enhanced control. The movement translation component 130 may scale cursor movement based on the current zoom level of the application. The movement translation component 130 may apply directional filtering to constrain cursor movement along specific axes when appropriate. The movement translation component 130 may detect rapid finger movements and may adjust cursor responsiveness accordingly. The movement translation component 130 may provide the translated cursor position to the cursor rendering module.

The boundary enforcement component 132 may be configured to ensure that the cursor may remain within valid display boundaries during engaged movement. The boundary enforcement component 132 may receive the calculated cursor position from the movement translation component 130. The boundary enforcement component 132 may retrieve the display dimensions from system configuration data. The boundary enforcement component 132 may compare the cursor x-coordinate against the left and right display boundaries. The boundary enforcement component 132 may compare the cursor y-coordinate against the top and bottom display boundaries. The boundary enforcement component 132 may detect when the cursor position may exceed any boundary. The boundary enforcement component 132 may clamp the cursor position to the nearest valid coordinate within the display area. The boundary enforcement component 132 may generate a boundary collision event when the cursor may reach a display edge. The boundary enforcement component 132 may provide feedback to the dynamic offset adjuster 122 to modify the offset when boundary constraints may be active. The boundary enforcement component 132 may implement elastic boundary behavior where the cursor may resist movement near edges. The boundary enforcement component 132 may provide the constrained cursor position to the cursor rendering module.

The hover detection component 134 may be configured to identify when the cursor may be in a hover-like state over a user interface element. The hover detection component 134 may monitor cursor velocity from the cursor tracking component 128. The hover detection component 134 may detect when cursor velocity may fall below a predetermined hover threshold. The hover detection component 134 may start a hover timer when the cursor may become substantially stationary. The hover detection component 134 may compare the elapsed hover time against a configurable hover duration threshold. The hover detection component 134 may perform hit-testing to identify the user interface element beneath the cursor position. The hover detection component 134 may generate a hover-start event when the hover duration threshold may be exceeded. The hover detection component 134 may provide the identified user interface element information to the application layer. The hover detection component 134 may monitor for cursor movement that may exceed a hover position tolerance. The hover detection component 134 may generate a hover-end event when the cursor may move beyond the position tolerance. The hover detection component 134 may reset the hover timer when hover may be interrupted. The hover detection component 134 may support multiple hover states for different user interface element types.

The visual state maintenance component 136 may be configured to manage the appearance of visual feedback elements during the engaged movement phase. The visual state maintenance component 136 may receive the cursor state information from the cursor state controller. The visual state maintenance component 136 may maintain the visual tension indicator in an engaged state appearance. The visual state maintenance component 136 may modify the visual indicator properties to reflect the unlocked cursor state. The visual state maintenance component 136 may render the visual indicator with properties indicating active engagement. The visual state maintenance component 136 may update the visual indicator endpoint to track the current finger position. The visual state maintenance component 136 may maintain the visual indicator origin at the reference point. The visual state maintenance component 136 may apply visual effects to indicate hover state when detected by the hover detection component 134. The visual state maintenance component 136 may modify cursor appearance based on the underlying user interface element. The visual state maintenance component 136 may provide visual feedback for boundary collision events. The visual state maintenance component 136 may coordinate with the cursor rendering module to ensure consistent visual presentation. The visual state maintenance component 136 may support customizable visual themes for the engaged movement state.

Advanced visual indicator designs may provide sophisticated feedback mechanisms beyond basic line representations. Animated transitions may include smooth morphing between different indicator states, particle effects that follow the tension line, and dynamic color gradients that reflect tension intensity. Three-dimensional visual indicators may provide depth cues through shadows, perspective effects, and layered visual elements. Contextual indicator shapes may adapt based on the underlying interface elements, such as circular indicators for buttons or linear indicators for sliders. Customizable visual themes may allow users to select from various aesthetic options including minimalist designs, high-visibility modes, and application-specific styling. The system may support custom indicator graphics and animations through plugin architectures or user-defined visual assets.

The engaged movement module 126 may incorporate accessibility features and alternative feedback modes to accommodate users with diverse needs. Haptic feedback patterns may provide tactile confirmation when tension thresholds are reached, with varying vibration intensities corresponding to different tension levels. Audio cues may include spatial audio feedback that indicates cursor position and tension state through stereo positioning and frequency modulation. High-contrast visual modes may enhance visual indicators with increased opacity, bold colors, and larger indicator sizes for users with visual impairments. Voice-guided interaction may provide spoken feedback describing cursor position, available actions, and tension state. The system may support external assistive devices such as switch controls and eye-tracking systems for alternative input methods.

### D. A Secondary Process Module

The tension-based precision touch input mechanism 100 may include a secondary process module 138. secondary process module 138 may include hardware and/or software configured to manage additional interaction capabilities that may be initiated after the cursor may be unlocked and actively moving. The secondary process module 138 may comprise a secondary touch detector 140, an action mode selector 142, a combined input processor 144, a drag operation controller 146, and a secondary action finalizer 148.

The secondary touch detector 140 may be configured to monitor for additional touch inputs while the primary finger may maintain cursor control. The secondary touch detector 140 may receive touch event data from the touch detection component 104. The secondary touch detector 140 may distinguish between the primary touch and secondary touch based on touch identifiers. The secondary touch detector 140 may detect when a second finger may make contact with the display surface. The secondary touch detector 140 may record the coordinates of the secondary touch event. The secondary touch detector 140 may timestamp the secondary touch event for temporal correlation with primary touch events. The secondary touch detector 140 may generate a secondary touch notification event. The secondary touch detector 140 may provide the secondary touch coordinates to the action mode selector 142. The secondary touch detector 140 may monitor for secondary touch release events. The secondary touch detector 140 may maintain a registry of active touch points for multi-touch tracking.

The action mode selector 142 may be configured to determine the appropriate action type based on the secondary touch input and current system context. The action mode selector 142 may receive the secondary touch coordinates from the secondary touch detector 140. The action mode selector 142 may receive the current cursor position from the offset application component 124. The action mode selector 142 may calculate the spatial relationship between the secondary touch location and the cursor position. The action mode selector 142 may retrieve the current application context from the application integration interface. The action mode selector 142 may access user preference settings for secondary action mappings. The action mode selector 142 may determine whether the secondary touch may initiate a drag operation. The action mode selector 142 may determine whether the secondary touch may initiate a selection lock operation. The action mode selector 142 may determine whether the secondary touch may initiate a context-specific action. The action mode selector 142 may select an action mode from a predefined set of available modes. The action mode selector 142 may generate an action mode selection event. The action mode selector 142 may provide the selected action mode to the combined input processor 144.

The combined input processor 144 may be configured to coordinate the processing of simultaneous inputs from the primary finger and the secondary finger. The combined input processor 144 may receive the selected action mode from the action mode selector 142. The combined input processor 144 may receive continuous position updates for the primary finger from the coordinate capture component 106. The combined input processor 144 may receive continuous position updates for the secondary finger from the secondary touch detector 140. The combined input processor 144 may maintain the cursor position tracking based on the primary finger movement. The combined input processor 144 may calculate the offset cursor position using the offset application component 124. The combined input processor 144 may process the secondary finger position in the context of the selected action mode. The combined input processor 144 may generate composite input events that may combine primary and secondary finger data. The combined input processor 144 may coordinate timing between primary and secondary input streams. The combined input processor 144 may apply filtering to prevent conflicting input interpretations. The combined input processor 144 may provide the composite input data to the drag operation controller 146 when drag mode may be active.

The drag operation controller 146 may be configured to manage drag-and-drop or drag-to-manipulate operations initiated by the secondary touch. The drag operation controller 146 may receive composite input data from the combined input processor 144. The drag operation controller 146 may identify the user interface element at the cursor position as the drag target. The drag operation controller 146 may lock the drag target to the cursor position. The drag operation controller 146 may track the cursor movement as the primary finger may move. The drag operation controller 146 may update the drag target position to follow the cursor position. The drag operation controller 146 may apply constraints to the drag operation based on application rules. The drag operation controller 146 may detect collision with other user interface elements during the drag. The drag operation controller 146 may provide visual feedback indicating the drag operation may be in progress. The drag operation controller 146 may calculate drop zones or snap points for the drag target. The drag operation controller 146 may generate drag-in-progress events for the application layer. The drag operation controller 146 may monitor for secondary finger release to complete the drag operation.

The secondary action finalizer 148 may be configured to complete and finalize secondary actions when the secondary finger may be released. The secondary action finalizer 148 may detect the secondary finger lift-off event from the secondary touch detector 140. The secondary action finalizer 148 may determine the final state of the secondary action based on the action mode. The secondary action finalizer 148 may calculate the final position of any manipulated elements. The secondary action finalizer 148 may validate the secondary action against application constraints. The secondary action finalizer 148 may generate a secondary action commit event. The secondary action finalizer 148 may provide the final action parameters to the application layer. The secondary action finalizer 148 may update the visual state to reflect the completed secondary action. The secondary action finalizer 148 may determine whether the primary finger may still be in contact with the display. The secondary action finalizer 148 may maintain the cursor in the unlocked state if the primary finger may remain in contact. The secondary action finalizer 148 may transition the system back to the engaged movement state after secondary action completion.

The secondary process module 138 may include conflict resolution mechanisms to distinguish tension-based input from other multi-touch gestures. The system may analyze touch patterns to differentiate between tension gestures and pinch-zoom operations by monitoring the number of simultaneous touch points and their relative movements. System navigation swipe detection may be implemented through velocity analysis and edge proximity detection to prevent interference with tension-based interactions. Palm rejection algorithms may utilize touch size, pressure distribution, and contact area analysis to filter out unintentional palm contacts. The system may implement gesture priority hierarchies where tension-based input takes precedence over certain system gestures when explicitly activated.

### III. Platform Operation

Embodiments of the present disclosure provide a hardware and software platform operative by a set of methods and computer-readable media comprising instructions configured to operate the aforementioned modules and computing elements in accordance with the methods. The following depicts an example of at least one method of a plurality of methods that may be performed by at least one of the aforementioned modules. Various hardware components may be used at the various stages of operations disclosed with reference to each module.

For example, although methods may be described as being performed by a single computing device, it should be understood that, in some embodiments, different operations may be performed by different networked elements in operative communication with the computing device. For example, at least one computing device 700 may be employed in the performance of some or all of the stages disclosed with regard to the methods. Similarly, an apparatus may be employed in the performance of some or all of the stages of the methods. As such, the apparatus may comprise at least those architectural components found in computing device 700.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones described below. Moreover, various stages may be added or removed from the method without altering or departing from the fundamental scope of the depicted methods and systems disclosed herein.

### A. Master Method

Consistent with embodiments of the present disclosure, a method may be performed by at least one of the aforementioned modules. The method may be embodied as, for example, but not limited to, computer instructions, which, when executed, perform the method.

The method may provide a comprehensive approach to precision touch input on touchscreen devices through a tension-based interaction paradigm. The method may begin with detecting an initial touch at a first location on a touchscreen display, which may be stored as a starting point for subsequent tension measurement. As the user's finger may move away from this starting point while maintaining contact with the display surface, the system may continuously track the current finger position and may compute a tension value based on the distance between the starting point and the current location. A visual indicator may be rendered that extends between the first location and the current location, with at least one visual property of this indicator varying as a function of the computed tension value to provide real-time feedback to the user regarding the current tension state.

The method may employ a threshold-based cursor activation mechanism wherein the cursor may remain locked at the first location while the tension value remains below a predefined threshold. This locked state may prevent accidental cursor movements and may ensure that cursor activation occurs only through deliberate user intent. When the tension value may meet or exceed the predefined threshold, the system may modify the visual indicator to indicate an engaged state, signaling to the user that the cursor is now ready for precision control. Upon threshold achievement, the method may enable movement of the cursor based on the current location of the user's finger, but with a calculated offset from the current location such that the cursor may be visually separated from the touch point. This offset positioning may prevent the user's finger from occluding the cursor, thereby enabling the user to maintain an unobstructed view of the cursor position and the target area throughout the interaction, facilitating pixel-level precision manipulation that may be difficult or impossible to achieve with conventional direct-touch interfaces.

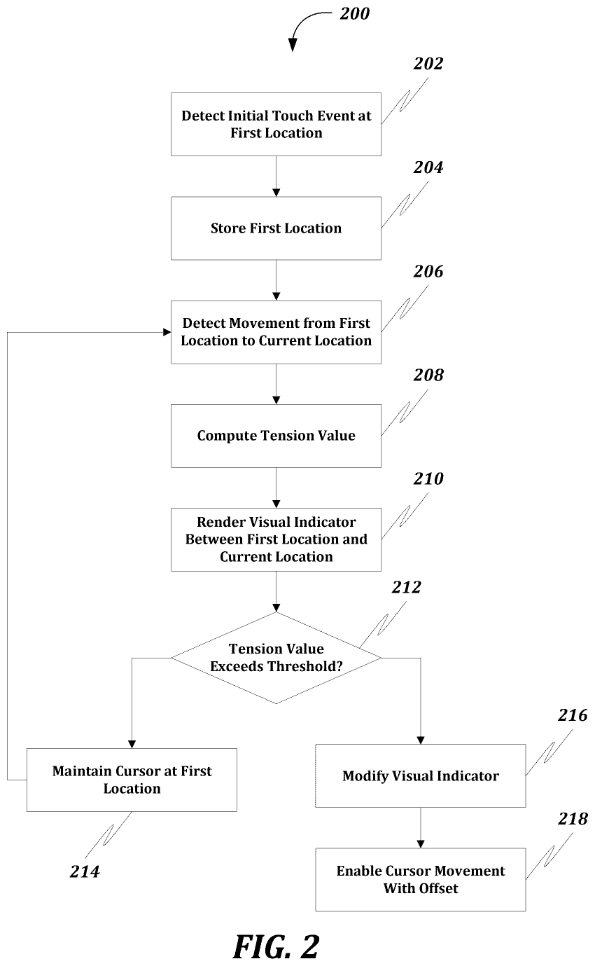

Referring now to FIG. 2, a method 200 for tension-based precision touch input on a touchscreen device may be described. The method 200 may comprise a sequence of stages that may enable a user to perform pixel-level cursor control without finger occlusion. Each stage of the method 200 may be performed by one or more components of the tension-based precision touch input mechanism 100 described above. The method 200 may begin at a starting point and may proceed through multiple stages as illustrated in FIG. 2.

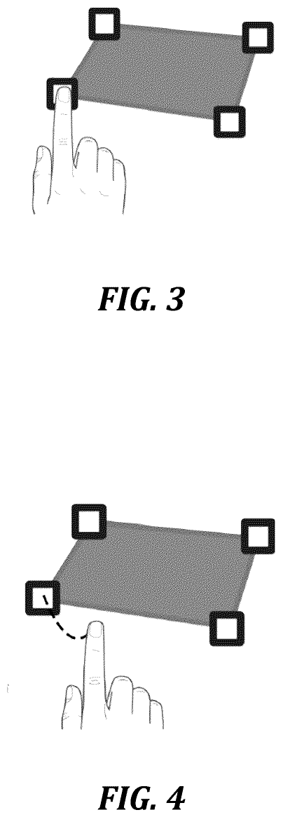

At stage 202, an initial touch event may be detected at a first location on a touchscreen display, as shown in FIG. 3. The touch detection component 104 may monitor the touch-sensitive display for contact events. When a user's finger may make initial contact with the display surface, the touch detection component 104 may generate a touch-down event signal. The touch detection component 104 may interface with a capacitive or resistive sensor array to detect the presence of the user's finger. The touch detection component 104 may distinguish the initial contact from ongoing contact or multi-touch scenarios. The touch detection component 104 may filter spurious touch events to ensure reliable detection of the initial touch. The coordinate capture component 106 may receive touch position data from the touch detection component 104. The coordinate capture component 106 may determine the spatial coordinates of the initial touch event. The coordinate capture component 106 may normalize raw sensor coordinates to display pixel coordinates. The coordinate capture component 106 may timestamp the coordinate data for temporal analysis. The coordinate capture component 106 may associate the coordinates with a unique touch identifier for multi-touch tracking purposes.

In an example embodiment, a user may be working with a graphic design application on a tablet device. The user may wish to manipulate an edit node in a vector graphics path. The user may place a finger on the touchscreen display at a location near the edit node. The touch detection component 104 may detect the initial contact. The coordinate capture component 106 may record the coordinates of the touch point as (xₒ, yₒ). The system may associate this touch with a unique identifier to distinguish it from potential subsequent touches. The touch detection component 104 may verify that the contact meets minimum pressure and contact area thresholds to distinguish intentional touch from accidental contact.

In another example embodiment, a user may be editing text in a word processing application. The user may wish to position a text cursor at a specific character location within a line of text. The user may touch the display at a location near the desired insertion point. The touch detection component 104 may detect the initial touch event. The coordinate capture component 106 may capture the initial coordinates. The system may identify that the touch occurred within a text editing context. The touch detection component 104 may apply context-specific filtering to ensure the touch is interpreted as a cursor positioning gesture rather than a text selection gesture.

At stage 204, the first location may be stored as a starting point. The reference point storage component 108 may receive the initial touch coordinates from the coordinate capture component 106. The reference point storage component 108 may allocate memory space for storing the reference point coordinates. The reference point storage component 108 may preserve the initial touch coordinates as a reference point for subsequent tension calculations. The reference point storage component 108 may maintain the reference point data throughout the duration of the touch interaction. The reference point storage component 108 may associate the reference point with the corresponding touch identifier. The reference point storage component 108 may provide access to the stored reference point for other system components. The cursor initialization component 110 may receive notification that a reference point has been established. The cursor initialization component 110 may set the cursor coordinates to match the reference point coordinates. The cursor initialization component 110 may render the cursor graphic at the initial position. The cursor initialization component 110 may set the cursor state to a locked configuration. The cursor initialization component 110 may prepare the cursor for subsequent state transitions.

In an example embodiment, the reference point storage component 108 may store the coordinates (xₒ, yₒ) in a dedicated memory structure. The memory structure may include fields for the x-coordinate, y-coordinate, timestamp, and touch identifier. The reference point storage component 108 may mark the reference point as active. The cursor initialization component 110 may create a cursor object at the reference point location. The cursor may be rendered as a crosshair graphic to indicate precision targeting capability. The cursor state may be set to “locked” to prevent movement until the tension threshold may be exceeded. The cursor initialization component 110 may register the cursor with the graphics rendering pipeline for display on the touchscreen.

In another example embodiment, the reference point storage component 108 may store the reference point in a circular buffer that may maintain a history of recent reference points. This buffer may enable the system to support rapid successive interactions without memory allocation overhead. The cursor initialization component 110 may select a cursor appearance based on the application context. For a graphic design application, the cursor may be rendered as a small circle with a center dot. For a text editing application, the cursor may be rendered as a vertical line. The cursor initialization component 110 may apply a visual effect to the cursor to indicate the locked state, such as a pulsing animation or a lock icon overlay.

At stage 206, movement of the touch from the first location to a current location may be detected, as shown in FIG. 4. The coordinate capture component 106 may continue to monitor the touch sensor array while the user's finger may remain in contact with the display surface. The coordinate capture component 106 may detect changes in the finger position as the user may move the finger across the screen. The coordinate capture component 106 may generate a continuous stream of position updates. Each position update may include current coordinates (xₙ, yₙ) and a timestamp. The coordinate capture component 106 may maintain a position history buffer storing recent finger positions. The coordinate capture component 106 may calculate finger movement velocity based on position changes over time. The coordinate capture component 106 may provide the current finger position to the displacement vector analyzer 116. The displacement vector analyzer 116 may receive the reference point coordinates from the reference point storage component 108. The displacement vector analyzer 116 may receive the current finger position coordinates from the coordinate capture component 106. The displacement vector analyzer 116 may calculate the horizontal displacement component as the difference between the current x-coordinate and the reference x-coordinate. The displacement vector analyzer 116 may calculate the vertical displacement component as the difference between the current y-coordinate and the reference y-coordinate.

In an example embodiment, the user may move the finger away from the initial touch point in an upward and rightward direction. The coordinate capture component 106 may detect the finger movement and may generate position updates at a rate of 120 Hz. Each position update may include coordinates (xₙ, yₙ) representing the current finger location. The displacement vector analyzer 116 may calculate the displacement vector components as Δx=xₙ−xₒ and Δy=yₙ−yₒ. For example, if the initial touch point may be at coordinates (100, 200) and the current finger position may be at coordinates (150, 150), the displacement vector may be Δx=50 pixels and Δy=−50 pixels. The displacement vector analyzer 116 may determine that the finger has moved 50 pixels to the right and 50 pixels upward.

In another example embodiment, the user may move the finger in a circular motion around the initial touch point. The coordinate capture component 106 may track the circular movement path. The displacement vector analyzer 116 may calculate displacement vectors for each position update. The displacement magnitude may vary as the finger moves closer to or farther from the reference point during the circular motion. The coordinate capture component 106 may maintain a position history buffer containing the last 10 position samples. This buffer may enable the system to calculate movement velocity and acceleration for enhanced responsiveness.

At stage 208, a tension value may be computed based on a distance between the starting point and the current location. The displacement vector analyzer 116 may calculate the displacement magnitude as the Euclidean distance between the reference point and the current finger position. The displacement magnitude D may be computed as D=√(Δx²+Δy²). A tension calculation module may receive the displacement magnitude from the displacement vector analyzer 116. The tension calculation module may apply a tension function to convert the displacement magnitude to a tension value. The tension function may be linear, such that T=k×D, where k may be a scaling constant. Alternatively, the tension function may be non-linear, such as quadratic, exponential, or a custom curve. The tension calculation module may normalize the tension value to a standard range, such as 0 to 1 or 0 to 100. The tension calculation module may apply temporal filtering to smooth the tension value and reduce jitter. The tension calculation module may provide the computed tension value to a threshold comparison module and to a visual feedback rendering module.

In some embodiments, the tension calculation may employ various mathematical algorithms to determine the tension value with precision. The system may calculate Euclidean distance using the formula: tension =√[(x₂−x₁)²+(y₂−y₁)²], where (x₁, y₁) represents the starting point and (x₂, y₂) represents the current location. The tension calculation may incorporate non-linear functions such as exponential or logarithmic scaling to provide more intuitive user feedback. The system may apply velocity-based adjustments by factoring the rate of movement, where rapid movements may increase the effective tension value. Normalization algorithms may scale tension values across different screen sizes and resolutions to maintain consistent behavior across various devices.

In an example embodiment, the displacement magnitude may be calculated as D=√(50²+50²)=√(2500+2500)=√5000≈70.7 pixels. The tension calculation module may apply a linear tension function with a scaling constant k=0.5. The tension value may be computed as T=0.5×70.7≈35.4. The tension calculation module may normalize this value to a range of 0 to 100, resulting in a normalized tension value of approximately 35.4%. The tension calculation module may apply a low-pass filter to smooth the tension value over the last 5 samples to reduce noise from finger tremor.

In another example embodiment, the tension calculation module may apply a non-linear tension function to provide more gradual tension increase at small displacements and more rapid increase at larger displacements. The tension function may be T=(D/Dₘₐₓ)², where Dₘₐₓ may be a maximum expected displacement distance. For a displacement of 70.7 pixels and a maximum displacement of 200 pixels, the tension value may be T=(70.7/200)²=(0.3535)²≈0.125 or 12.5%. This non-linear function may provide finer control at small displacements while still allowing rapid tension buildup at larger displacements.

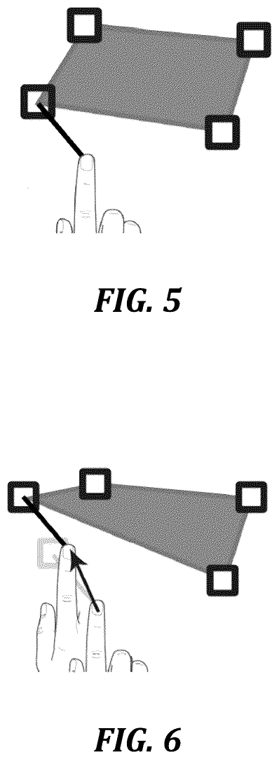

At stage 210, a visual indicator may be rendered between the first location and the current location, as shown in FIG. 5. The visual indicator initialization component 112 may create an initial visual tension indicator at the reference point. The visual indicator initialization component 112 may generate a graphical element representing the tension indicator. The visual indicator initialization component 112 may set initial visual properties corresponding to zero or minimal tension. The visual indicator initialization component 112 may position the indicator at the reference point coordinates. The visual indicator initialization component 112 may register the indicator with the rendering pipeline for subsequent updates. A visual feedback rendering module may receive the tension magnitude value from the tension calculation module. The visual feedback rendering module may map the tension value to visual property values using transfer functions. The visual feedback rendering module may modify one or more visual properties selected from pattern, color, opacity, thickness, and shape. The visual feedback rendering module may generate visual indicator geometry connecting the reference point to the current finger position. The visual feedback rendering module may render the indicator using a graphics API. The visual feedback rendering module may update the indicator in real-time synchronized with the display refresh rate.

In an example embodiment, the visual feedback rendering module may render a line segment extending from the reference point at coordinates (100, 200) to the current finger position at coordinates (150, 150). The line segment may be rendered with visual properties that may vary based on the tension value of 35.4%. The pattern property may be set to a dashed line pattern with a dash length that may increase as tension increases. At 35.4% tension, the dash length may be interpolated to a medium value. The color property may be set by interpolating along a color gradient from blue (at 0% tension) to green (at 50% tension) to yellow (at 75% tension) to red (at 100% tension). At 35.4% tension, the color may be a blue-green shade. The opacity property may be set to 0.354(35.4 % opaque). The thickness property may be set to 2 pixels, interpolated from 1 pixel at 0% tension to 4 pixels at 100% tension. The visual feedback rendering module may submit rendering commands to the GPU to draw the line with these properties.

In another example embodiment, the visual feedback rendering module may render the visual indicator as a curved path rather than a straight line. The path may follow a Bezier curve from the reference point to the current finger position. The shape of the curve may change based on the tension value, becoming more pronounced as tension increases. The visual feedback rendering module may also render an arrowhead at the current finger position end of the indicator to show the direction of movement. The arrowhead size may increase with tension. Additionally, the visual feedback rendering module may render a circular highlight at the reference point that may pulse with a frequency proportional to the tension value, providing an additional visual cue of the tension state.

The visual feedback rendering module may support simultaneous modification of multiple visual properties to provide redundant feedback channels. This multi-dimensional feedback approach may ensure that the tension state may be communicated effectively even if the user may have difficulty perceiving changes in one particular visual property. For example, a user with color vision deficiency may still perceive tension changes through pattern, opacity, and thickness variations even if color changes may be less apparent.

At stage 212, the tension value may be compared to a predefined threshold. A threshold comparison module may receive the current tension magnitude from the tension calculation module. The threshold comparison module may retrieve a predefined tension threshold value from a configuration storage. The threshold comparison module may compare the current tension value against the threshold. The threshold comparison module may evaluate whether the tension value may be less than the threshold or may be greater than or equal to the threshold. The threshold comparison module may generate a comparison result indicating whether the threshold has been exceeded. The threshold comparison module may provide the comparison result to a cursor state controller. The threshold comparison module may implement hysteresis to prevent oscillation near the threshold boundary. The hysteresis may define a lower threshold for unlocking and a slightly higher threshold for re-locking if the tension may decrease after unlocking.

In an example embodiment, the predefined threshold may be set to 50 units on a scale of 0 to 100. The current tension value may be 35.4 units. The threshold comparison module may compare 35.4 to 50 and may determine that the tension value may be below the threshold. The threshold comparison module may generate a comparison result of “threshold not exceeded.” The threshold comparison module may provide this result to the cursor state controller. The cursor state controller may maintain the cursor in the locked state. The method 200 may proceed to stage 214.

In another example embodiment, the predefined threshold may be configurable by the user through a settings interface. A user who may prefer more deliberate engagement may set the threshold to a higher value, such as 70 units. A user who may prefer more responsive engagement may set the threshold to a lower value, such as 30 units. The threshold comparison module may retrieve the user-configured threshold value from persistent storage. The threshold comparison module may apply the user-configured threshold in the comparison operation. Additionally, the threshold comparison module may implement context-dependent threshold adjustment. For example, when the user may be working in a graphic design application with small edit nodes, the threshold may be automatically reduced to 40 units to enable quicker engagement. When the user may be working in a mapping application with larger target areas, the threshold may be automatically increased to 60 units to prevent accidental engagement.

At stage 214, if the tension value is below the predefined threshold, the cursor may be maintained at the first location. The cursor state controller may receive the comparison result from the threshold comparison module indicating that the threshold has not been exceeded. The cursor state controller may maintain the cursor state as “locked.” The cursor state controller may ensure that the cursor position may remain fixed at the reference point coordinates. The cursor rendering module may continue to render the cursor at the reference point location. The cursor may not move in response to finger movement while the cursor may be in the locked state. The visual feedback rendering module may continue to update the visual indicator to reflect the current tension level. The method 200 may return to stage 206 to continue detecting movement and updating the tension value. This loop may continue until either the tension threshold may be exceeded, or the user may lift the finger from the display.

In an example embodiment, the cursor may remain displayed at the reference point coordinates (100, 200) while the user's finger may move to coordinates (150, 150). The cursor may not follow the finger movement. The cursor rendering module may render the cursor as a stationary crosshair at the reference point. The visual indicator may extend from the cursor position to the current finger position, visually connecting the two points. The user may observe that the cursor may be locked in place while the visual indicator may grow and may change appearance as the finger moves farther from the reference point. This visual feedback may communicate to the user that additional finger movement may be required to unlock the cursor.

In another example embodiment, the cursor rendering module may apply a visual effect to the cursor to emphasize the locked state. The cursor may be rendered with a lock icon overlay. The cursor may be rendered with reduced opacity to indicate that it may not be active. The cursor may be rendered with a pulsing animation that may synchronize with the tension level, pulsing faster as tension increases. These visual cues may help the user understand the current system state and may provide feedback about how much additional finger movement may be needed to achieve threshold.

At stage 216, if the tension value meets or exceeds the predefined threshold, the visual indicator may be modified to indicate an engaged state. The threshold comparison module may determine that the tension value may be greater than or equal to the threshold. The threshold comparison module may generate a comparison result of “threshold exceeded.” The threshold comparison module may provide this result to the cursor state controller. The cursor state controller may transition the cursor state from “locked” to “unlocked.” The cursor state controller may generate a cursor unlock event. The visual feedback rendering module may receive notification of the state transition. The visual feedback rendering module may modify the visual properties of the indicator to signal the engaged state. The modification may include changing the line pattern from dashed to solid. The modification may include changing the color to a distinct engaged-state color such as green or yellow. The modification may include increasing the opacity to fully opaque. The modification may include increasing the thickness. The modification may include adding a visual effect such as a glow or pulse animation. The visual feedback rendering module may render the modified indicator to provide clear visual confirmation to the user that the cursor has been unlocked.

In an example embodiment, when the tension value may reach 50 units (meeting the threshold of 50), the threshold comparison module may generate a threshold exceeded event. The visual feedback rendering module may immediately modify the visual indicator appearance. The line pattern may change from a dashed pattern to a solid line. The color may change from the blue-green shade to a bright green color. The opacity may increase from 0.5 to 1.0 (fully opaque). The thickness may increase from 2 pixels to 3 pixels. Additionally, a brief animation effect may be applied where the line may pulse or flash once to draw the user's attention to the state change. This combination of visual changes may provide unmistakable feedback that the cursor has been unlocked and may be ready for precision control.

In another example embodiment, the visual feedback rendering module may modify the shape of the visual indicator upon threshold achievement. The indicator may transform from a simple line to an arrow shape pointing from the reference point toward the current finger position. The arrowhead may emphasize the direction of movement and may indicate that the cursor may now follow finger movement in that direction. The visual feedback rendering module may also render a circular highlight or halo effect around the cursor to draw attention to the cursor position. The highlight may fade in over a brief animation period to provide smooth visual feedback rather than an abrupt change.

At stage 218, cursor movement with an offset from the current location may be enabled, as shown in FIG. 6, such that the cursor may be visually separated from the touch. The cursor state controller may enable cursor movement in response to the threshold exceeded event. The offset calculation module may determine an offset vector to position the cursor away from the finger contact point. The offset vector calculator 118 may receive the displacement vector from the displacement vector analyzer 116. The offset vector calculator 118 may apply a predefined offset distance value. The offset vector calculator 118 may calculate the offset vector perpendicular to the displacement vector to position the cursor away from the finger. Alternatively, the offset vector calculator 118 may calculate the offset vector in a fixed direction relative to the display orientation. The offset vector calculator 118 may compute the offset vector components in display coordinate space. The offset application component 124 may receive the adjusted offset vector. The offset application component 124 may receive the current finger position from the coordinate capture component 106. The offset application component 124 may add the offset vector components to the finger position coordinates. The offset application component 124 may compute the final cursor x-coordinate as the sum of the finger x-coordinate and the offset x-component. The offset application component 124 may compute the final cursor y-coordinate as the sum of the finger y-coordinate and the offset y-component. The cursor rendering module may render the cursor at the offset position. The cursor may now move in correspondence with finger movement while maintaining the offset.

In an example embodiment, the offset vector calculator 118 may determine an offset vector that may position the cursor 50 pixels above the current finger position. The offset vector may be (0, −50) in display coordinates where negative y-values may represent upward direction. If the current finger position may be at coordinates (150, 150), the offset application component 124 may calculate the cursor position as (150+0, 150+(−50))=(150, 100). The cursor may be rendered at coordinates (150, 100), which may be 50 pixels directly above the finger contact point. As the user may move the finger to a new position such as (160, 140), the cursor may move to (160, 90), maintaining the 50-pixel upward offset. This offset may prevent the user's finger from occluding the cursor, enabling the user to see the cursor position clearly throughout the interaction.

In another example embodiment, the offset vector calculator 118 may calculate the offset vector in a direction perpendicular to the displacement vector. The displacement vector from the reference point (100, 200) to the current finger position (150, 150) may be (50, −50). A perpendicular vector may be calculated by rotating the displacement vector by 90 degrees. One perpendicular vector may be (50, 50) (rotated counterclockwise). The offset vector calculator 118 may normalize this perpendicular vector to unit length and may scale it by a desired offset distance of 40 pixels. The resulting offset vector may be approximately (28.3, 28.3). The cursor position may be calculated as (150+28.3, 150+28.3)=(178.3, 178.3). This perpendicular offset may position the cursor to the side of the finger rather than directly above it, which may be preferable in some interaction contexts.

The boundary constraint processor 120 may ensure that the offset cursor position may remain within the valid display area. The boundary constraint processor 120 may receive the calculated offset vector from the offset vector calculator 118. The boundary constraint processor 120 may receive the current finger position coordinates. The boundary constraint processor 120 may compute a preliminary cursor position by adding the offset vector to the finger position. The boundary constraint processor 120 may compare the preliminary cursor position against the display boundaries. If the preliminary cursor position may exceed a display boundary, the boundary constraint processor 120 may adjust the offset vector to constrain the cursor position within the display boundaries. For example, if the calculated cursor position may be (1850, 100) but the display width may be 1800 pixels, the boundary constraint processor 120 may clamp the cursor x-coordinate to 1800. The boundary constraint processor 120 may provide the constrained offset vector to the dynamic offset adjuster 122.

The dynamic offset adjuster 122 may modify the offset vector in response to changing interaction conditions. The dynamic offset adjuster 122 may monitor the proximity of the cursor to display edges. If the cursor may approach a display edge, the dynamic offset adjuster 122 may reduce the offset magnitude or may rotate the offset direction to keep the cursor visible and within bounds. The dynamic offset adjuster 122 may adjust the offset based on the current application context. For applications requiring greater precision, the dynamic offset adjuster 122 may increase the offset magnitude to provide more separation between the finger and cursor. For applications with larger target elements, the dynamic offset adjuster 122 may decrease the offset magnitude. The dynamic offset adjuster 122 may apply smoothing to offset adjustments to prevent abrupt cursor movements that may be disorienting to the user.

The movement translation component 130 may convert finger movements into corresponding cursor movements while maintaining the offset relationship. The movement translation component 130 may receive current finger position updates from the coordinate capture component 106. The movement translation component 130 may receive the offset vector from the offset application component 124. The movement translation component 130 may calculate the new cursor position by adding the offset vector to the current finger position. The movement translation component 130 may apply motion smoothing algorithms to reduce jitter in cursor movement. The movement translation component 130 may implement velocity-based cursor acceleration for enhanced control. The movement translation component 130 may provide the translated cursor position to the cursor rendering module. The cursor rendering module may update the cursor display at the new position. The cursor may move smoothly across the display in response to finger movement, maintaining the offset distance and direction.

In an example embodiment, as the user may move the finger from position (150, 150) to position (200, 120), the movement translation component 130 may calculate the new cursor position. With an offset vector of (0, −50), the cursor may move from (150, 100) to (200, 70). The cursor may follow the finger movement with a consistent 50-pixel upward offset. The user may observe the cursor moving smoothly across the display without being occluded by the finger. The user may be able to see the cursor position clearly and may be able to position the cursor precisely on a target element such as an edit node or text insertion point.

The method 200 may continue with the cursor in the unlocked state, responding to finger movement with the maintained offset. The user may perform precision manipulation tasks such as moving edit nodes, positioning a text cursor, drawing lines, or selecting small UI elements. The visual indicator may remain displayed, connecting the reference point to the current finger position, providing ongoing visual feedback of the spatial relationship. The cursor may remain unlocked and may continue to track finger movement until the user may lift the finger from the display, at which point the interaction may be finalized and the system may reset for the next interaction.

The method 200 may optionally include additional stages for hover-like interactions and secondary actions, as described in the detailed description of the engaged movement module 126 and the secondary process module 138. These optional stages may enable the user to pause cursor movement to inspect interface elements, to initiate drag operations using a second finger, or to perform other complex interactions while maintaining the precision control provided by the tension-based offset cursor mechanism.

### IV. Ahardware Architecture

Embodiments of the present disclosure provide a hardware and software platform operative as a distributed system of modules and computing elements.

Platform 100 may be embodied as, for example, but not be limited to, a website, a web application, a desktop application, a backend application, and a mobile application compatible with a computing device 700. The computing device 700 may comprise, but not be limited to, the following:
Mobile computing device, such as, but is not limited to, a laptop, a tablet, a smartphone, a drone, a wearable, an embedded device, a handheld device, an Arduino, an industrial device, or a remotely operable recording device;
A supercomputer, an exascale supercomputer, a mainframe, or a quantum computer;
A minicomputer, wherein the minicomputer computing device comprises, but is not limited to, an IBM AS400/iSeries/System I, A DEC VAX/PDP, an HP3000, a Honeywell-Bull DPS, a Texas Instruments TI-990, or a Wang Laboratories VS Series;
A microcomputer, wherein the microcomputer computing device comprises, but is not limited to, a server, wherein a server may be rack-mounted, a workstation, an industrial device, a raspberry pi, a desktop, or an embedded device;

Platform 100 may be hosted on a centralized server or a cloud computing service. Although method 200 has been described to be performed by a computing device 700, it should be understood that, in some embodiments, different operations may be performed by a plurality of the computing devices 700 in operative communication on at least one network.

Embodiments of the present disclosure may comprise a system having a central processing unit (CPU) 720, a bus 730, a memory unit 740, a power supply unit (PSU) 750, and one or more Input/Output (I/O) units. The CPU 720 coupled to the memory unit 740 and the plurality of I/O units 760 via the bus 730, all of which are powered by the PSU 750. It should be understood that, in some embodiments, each disclosed unit may actually be a plurality of such units for redundancy, high availability, and/or performance purposes. The combination of the presently disclosed units is configured to perform the stages of any method disclosed herein.

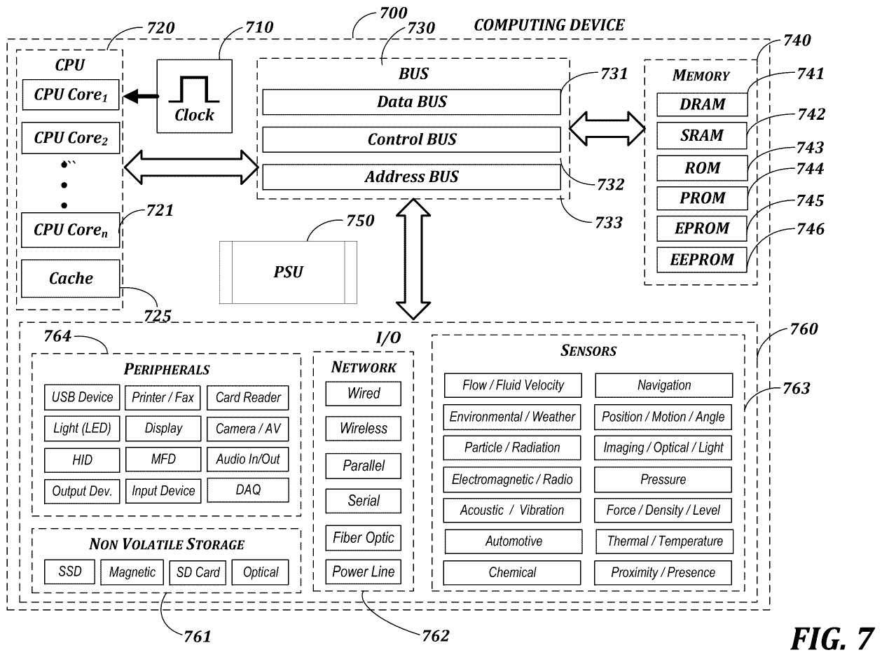

FIG. 7 is a block diagram of a system including computing device 700. Consistent with an embodiment of the disclosure, the aforementioned CPU 720, the bus 730, the memory unit 740, a PSU 750, and the plurality of I/O units 760 may be implemented in a computing device, such as computing device 700 of FIG. 7. Any suitable combination of hardware, software, or firmware may be used to implement the aforementioned units. For example, the CPU 720, the bus 730, and the memory unit 740 may be implemented with computing device 700 or any of other computing devices 700, in combination with computing device 700. The aforementioned system, device, and components are examples and other systems, devices, and components may comprise the aforementioned CPU 720, the bus 730, and the memory unit 740, consistent with embodiments of the disclosure.

At least one computing device 700 may be embodied as any of the computing elements illustrated in all of the attached figures. A computing device 700 does not need to be electronic, nor even have a CPU 720, nor bus 730, nor memory unit 740. The definition of the computing device 700 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 700, especially if the processing is purposeful.

With reference to FIG. 7, a system consistent with an embodiment of the disclosure may include a computing device, such as computing device 700. In some configurations, the computing device 700 may include at least one clock module 710, at least one CPU 720, at least one bus 730, and at least one memory unit 740, at least one PSU 750, and at least one I/O 760 module, wherein I/O module may be comprised of, but not limited to a non-volatile storage sub-module 761, a communication sub-module 762, a sensors sub-module 763, and a peripherals sub-module 764.

In a system consistent with an embodiment of the disclosure, the computing device 700 may include the clock module 710, known to a person having ordinary skill in the art as a clock generator, which produces clock signals. Clock signals may oscillate between a high state and a low state at a controllable rate, and may be used to synchronize or coordinate actions of digital circuits. Most integrated circuits (ICs) of sufficient complexity use a clock signal in order to synchronize different parts of the circuit, cycling at a rate slower than the worst-case internal propagation delays. One well-known example of the aforementioned integrated circuit is the CPU 720, the central component of modern computers, which relies on a clock signal. The clock 710 can comprise a plurality of embodiments, such as, but not limited to, a single-phase clock which transmits all clock signals on effectively 1 wire, a two-phase clock which distributes clock signals on two wires, each with non-overlapping pulses, and a four-phase clock which distributes clock signals on 4 wires.

Many computing devices 700 may use a “clock multiplier” which multiplies a lower frequency external clock to the appropriate clock rate of the CPU 720. This allows the CPU 720 to operate at a much higher frequency than the rest of the computing device 700, which affords performance gains in situations where the CPU 720 does not need to wait on an external factor (like memory 740 or input/output 760). Some embodiments of the clock 710 may include dynamic frequency change, where, the time between clock edges can vary widely from one edge to the next and back again.

In a system consistent with an embodiment of the disclosure, the computing device 700 may include the CPU 720 comprising at least one CPU Core 721. In other embodiments, the CPU 720 may include a plurality of identical CPU cores 721, such as, but not limited to, homogeneous multi-core systems. It is also possible for the plurality of CPU cores 721 to comprise different CPU cores 721, such as, but not limited to, heterogeneous multi-core systems, big. LITTLE systems and some AMD accelerated processing units (APU). The CPU 720 reads and executes program instructions which may be used across many application domains, for example, but not limited to, general purpose computing, embedded computing, network computing, digital signal processing (DSP), and graphics processing (GPU). The CPU 720 may run multiple instructions on separate CPU cores 721 simultaneously. The CPU 720 may be integrated into at least one of a single integrated circuit die, and multiple dies in a single chip package. The single integrated circuit die and/or the multiple dies in a single chip package may contain a plurality of other elements of the computing device 700, for example, but not limited to, the clock 710, the bus 730, the memory 740, and I/O 760.

The CPU 720 may contain cache 722 such as but not limited to a level 1 cache, a level 2 cache, a level 3 cache, or combinations thereof. The cache 722 may or may not be shared amongst a plurality of CPU cores 721. The cache 722 sharing may comprise at least one of message passing and inter-core communication methods used for the at least one CPU Core 721 to communicate with the cache 722. The inter-core communication methods may comprise, but not be limited to, bus, ring, two-dimensional mesh, and crossbar. The aforementioned CPU 720 may employ symmetric multiprocessing (SMP) design.

The one or more CPU cores 721 may comprise soft microprocessor cores on a single field programmable gate array (FPGA), such as semiconductor intellectual property cores (IP Core). The architectures of the one or more CPU cores 721 may be based on at least one of, but not limited to, Complex Instruction Set Computing (CISC), Zero Instruction Set Computing (ZISC), and Reduced Instruction Set Computing (RISC). At least one performance-enhancing method may be employed by one or more of the CPU cores 721, for example, but not limited to Instruction-level parallelism (ILP) such as, but not limited to, superscalar pipelining, and Thread-level parallelism (TLP).

Consistent with the embodiments of the present disclosure, the aforementioned computing device 700 may employ a communication system that transfers data between components inside the computing device 700, and/or the plurality of computing devices 700. The aforementioned communication system will be known to a person having ordinary skill in the art as a bus 730. The bus 730 may embody internal and/or external hardware and software components, for example, but not limited to a wire, an optical fiber, various communication protocols, and/or any physical arrangement that provides the same logical function as a parallel electrical bus. The bus 730 may comprise at least one of a parallel bus, wherein the parallel bus carries data words in parallel on multiple wires; and a serial bus, wherein the serial bus carries data in bit-wise serial form. The bus 730 may embody a plurality of topologies, for example, but not limited to, a multidrop/electrical parallel topology, a daisy chain topology, and connected by switched hubs, such as a USB bus. The bus 730 may comprise a plurality of embodiments, for example, but not limited to:
Internal data bus (data bus) 731/Memory bus
Control bus 732
Address bus 733
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as but not limited to, Accelerated Graphics Port (AGP), Peripheral Component Interconnect eXtended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal IO, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and eXtensible Host Controller Interface (xHCI).

Consistent with the embodiments of the present disclosure, the aforementioned computing device 700 may employ hardware integrated circuits that store information for immediate use in the computing device 700, known to persons having ordinary skill in the art as primary storage or memory 740. The memory 740 operates at high speed, distinguishing it from the non-volatile storage sub-module 761, which may be referred to as secondary or tertiary storage, which provides relatively slower-access to information but offers higher storage capacity. The data contained in memory 740, may be transferred to secondary storage via techniques such as, but not limited to, virtual memory and swap. The memory 740 may be associated with addressable semiconductor memory, such as integrated circuits consisting of silicon-based transistors, that may be used as primary storage or for other purposes in the computing device 700. The memory 740 may comprise a plurality of embodiments, such as, but not limited to volatile memory, non-volatile memory, and semi-volatile memory. It should be understood by a person having ordinary skill in the art that the following are non-limiting examples of the aforementioned memory:
Volatile memory, which requires power to maintain stored information, for example, but not limited to, Dynamic Random-Access Memory (DRAM) 741, Static Random-Access Memory (SRAM) 742, CPU Cache memory 725, Advanced Random-Access Memory (A-RAM), and other types of primary storage such as Random-Access Memory (RAM).
Non-volatile memory, which can retain stored information even after power is removed, for example, but not limited to, Read-Only Memory (ROM) 743, Programmable ROM (PROM) 744, Erasable PROM (EPROM) 745, Electrically Erasable PROM (EEPROM) 746 (e.g., flash memory and Electrically Alterable PROM [EAPROM]), Mask ROM (MROM), One Time Programmable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory may have limited non-volatile duration after power is removed but may lose data after said duration has passed. Semi-volatile memory provides high performance, durability, and other valuable characteristics typically associated with volatile memory, while providing some benefits of true non-volatile memory. The semi-volatile memory may comprise volatile and non-volatile memory, and/or volatile memory with a battery to provide power after power is removed. The semi-volatile memory may comprise, but is not limited to, spin-transfer torque RAM (STT-RAM).

Consistent with the embodiments of the present disclosure, the aforementioned computing device 700 may employ a communication system between an information processing system, such as the computing device 700, and the outside world, for example, but not limited to, human, environment, and another computing device 700. The aforementioned communication system may be known to a person having ordinary skill in the art as an Input/Output (I/O) module 760. The I/O module 760 regulates a plurality of inputs and outputs with regard to the computing device 700, wherein the inputs are a plurality of signals and data received by the computing device 700, and the outputs are the plurality of signals and data sent from the computing device 700. The I/O module 760 interfaces with a plurality of hardware, such as, but not limited to, non-volatile storage 761, communication devices 762, sensors 763, and peripherals 764. The plurality of hardware is used by at least one of, but not limited to, humans, the environment, and another computing device 700 to communicate with the present computing device 700. The I/O module 760 may comprise a plurality of forms, for example, but not limited to channel I/O, port mapped I/O, asynchronous I/O, and Direct Memory Access (DMA).

Consistent with the embodiments of the present disclosure, the aforementioned computing device 700 may employ a non-volatile storage sub-module 761, which may be referred to by a person having ordinary skill in the art as one of secondary storage, external memory, tertiary storage, off-line storage, and auxiliary storage. The non-volatile storage sub-module 761 may not be accessed directly by the CPU 720 without using an intermediate area in the memory 740. The non-volatile storage sub-module 761 may not lose data when power is removed and may be orders of magnitude less costly than storage used in memory 740. Further, the non-volatile storage sub-module 761 may have a slower speed and higher latency than in other areas of the computing device 700. The non-volatile storage sub-module 761 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (761) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD±RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the computing device 700 may employ a communication sub-module 762 as a subset of the I/O module 760, which may be referred to by a person having ordinary skill in the art as at least one of, but not limited to, a computer network, a data network, and a network. The network may allow computing devices 700 to exchange data using connections, which may also be known to a person having ordinary skill in the art as data links, which may include data links between network nodes. The nodes may comprise networked computer devices 700 that may be configured to originate, route, and/or terminate data. The nodes may be identified by network addresses and may include a plurality of hosts consistent with the embodiments of a computing device 700. Examples of computing devices that may include a communication sub-module 762 include, but are not limited to, personal computers, phones, servers, drones, and networking devices such as, but not limited to, hubs, switches, routers, modems, and firewalls.

Two nodes can be considered networked together when one computing device 700 can exchange information with the other computing device 700, regardless of any direct connection between the two computing devices 700. The communication sub-module 762 supports a plurality of applications and services, such as, but not limited to World Wide Web (WWW), digital video and audio, shared use of application and storage computing devices 700, printers/scanners/fax machines, email/online chat/instant messaging, remote control, distributed computing, etc. The network may comprise one or more transmission mediums, such as, but not limited to conductive wire, fiber optics, and wireless signals. The network may comprise one or more communications protocols to organize network traffic, wherein application-specific communications protocols may be layered, and may be known to a person having ordinary skill in the art as being improved for carrying a specific type of payload, when compared with other more general communications protocols. The plurality of communications protocols may comprise, but are not limited to, IEEE 802, ethernet, Wireless LAN (WLAN/Wi-Fi), Internet Protocol (IP) suite (e.g., TCP/IP, UDP, Internet Protocol version 4[IPv4], and Internet Protocol version 6 [IPv6 ]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], Integrated Digital Enhanced Network [IDEN], Long Term Evolution [LTE], LTE-Advanced [LTE-A], and fifth generation [5G] communication protocols).

The communication sub-module 762 may comprise a plurality of size, topology, traffic control mechanisms and organizational intent policies. The communication sub-module 762 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G,4G (such as WiMAX and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line communications

The aforementioned network may comprise a plurality of layouts, such as, but not limited to, bus networks such as Ethernet, star networks such as Wi-Fi, ring networks, mesh networks, fully connected networks, and tree networks. The network can be characterized by its physical capacity or its organizational purpose. Use of the network, including user authorization and access rights, may differ according to the layout of the network. The characterization may include, but is not limited to a nanoscale network, a Personal Area Network (PAN), a Local Area Network (LAN), a Home Area Network (HAN), a Storage Area Network (SAN), a Campus Area Network (CAN), a backbone network, a Metropolitan Area Network (MAN), a Wide Area Network (WAN), an enterprise private network, a Virtual Private Network (VPN), and a Global Area Network (GAN).

Consistent with the embodiments of the present disclosure, the aforementioned computing device 700 may employ a sensors sub-module 763 as a subset of the I/O 760. The sensors sub-module 763 comprises at least one of the device, module, or subsystem whose purpose is to detect events or changes in its environment and send the information to the computing device 700. Sensors may be sensitive to the property they are configured to measure, may not be sensitive to any property not measured but be encountered in its application, and may not significantly influence the measured property. The sensors sub-module 763 may comprise a plurality of digital devices and analog devices, wherein if an analog device is used, an Analog to Digital (A-to-D) converter must be employed to interface the said device with the computing device 700. The sensors may be subject to a plurality of deviations that limit sensor accuracy. The sensors sub-module 763 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte- insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).
Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/ automatic transmission/turbine/vehicle speed sensor, airbag sensors, brake fluid/engine crankcase/fuel/oil/tire pressure sensor, camshaft/crankshaft/throttle position sensor, fuel/il level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensors such as a guitar pickup, seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, moisture alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, airspeed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as but not limited to, accelerometer, displacement sensor, flex sensor, free-fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, colorimeter, contact image sensor, electro-optical sensor, infra-red sensor, kinetic inductance detector, LED configured as a light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 700 may employ a peripherals sub-module 764 as a subset of the I/O 760. The peripheral sub-module 764 comprises ancillary devices used to put information into and get information out of the computing device 700. There are 3 categories of devices comprising the peripheral sub-module 764, which exist based on their relationship with the computing device 700, input devices, output devices, and input/output devices. Input devices send at least one of data and instructions to the computing device 700. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to the position of a mouse.
The number of degrees of freedom involved, such as, but not limited to, two-dimensional mice and three-dimensional mice used for Computer-Aided Design (CAD) applications.

Output devices provide output from the computing device 700. Output devices convert electronically generated information into a form that can be presented to humans. Input/output devices perform that perform both input and output functions. It should be understood by a person having ordinary skill in the art that the ensuing are non-limiting embodiments of the aforementioned peripheral sub-module 764:
Input Devices
   Human Interface Devices (HID), such as, but not limited to, pointing device (e.g., mouse, touchpad, joystick, touchscreen, game controller/gamepad, remote, light pen, light gun, infrared remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, that require up to six degrees of freedom such as, but not limited to, camera gimbals, Cave Automatic Virtual Environment (CAVE), and virtual reality systems.
   Video Input devices are used to digitize images or video from the outside world into the computing device 700. The information can be stored in a multitude of formats depending on the user's requirement. Examples of types of video input devices include, but are not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device to capture produced sound. Audio input devices allow a user to send audio signals to the computing device 700 for at least one of processing, recording, and carrying out commands. Devices such as microphones allow users to speak to the computer to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
   Data AcQuisition (DAQ) devices convert at least one of analog signals and physical parameters to digital values for processing by the computing device 700. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices may convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).
   Printers, such as, but not limited to, inkjet printers, laser printers, 3D printers, solid ink printers, and plotters.
   Audio and Video (AV) devices, such as, but not limited to, speakers, headphones, amplifiers, and lights, which include lamps, strobes, DJ lighting, stage lighting, architectural lighting, special effect lighting, and lasers.
   Other devices such as Digital to Analog Converter (DAC)
Input/Output Devices may further comprise, but not be limited to, touchscreens, networking devices (e.g., devices disclosed in network sub-module 762), data storage devices (non-volatile storage 761), facsimile (FAX), and graphics/sound cards.

All rights, including copyrights in the code included herein, are vested in and the property of the Applicant. The Applicant retains and reserves all rights in the code included herein, and grants permission to reproduce the material only in connection with the reproduction of the granted patent and for no other purpose.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A method for precision touch input on a touchscreen device, the method comprising:
detecting an initial touch at a first location on a touchscreen display;
storing the first location as a starting point;
detecting movement of the touch from the starting point to a current location;
computing a tension value based on a distance between the starting point and the current location;
rendering a visual indicator that extends between the first location and the current location, wherein at least one visual property of the visual indicator varies as a function of the tension value;
comparing the tension value to a predefined threshold;
while the tension value is below the predefined threshold, maintaining a cursor at the first location; and
when the tension value meets or exceeds the predefined threshold:
modifying the visual indicator to indicate an engaged state; and
enabling movement of the cursor based on the current location with an offset from the current location such that the cursor is visually separated from the touch.

2. The method of claim 1, wherein the at least one visual property comprises one or more of: pattern, color, opacity, thickness, and shape of the visual indicator.

3. The method of claim 1, wherein the offset positions the cursor at a location that reduces occlusion of a target area by a finger performing the touch.

4. The method of claim 1, further comprising:
detecting a pause in movement of the touch while the cursor is in the engaged state; and
in response to the pause, entering a hover-like state that provides visual feedback for elements underlying the cursor without requiring an additional touch input.

5. The method of claim 1, further comprising:
while the cursor is in the engaged state, detecting a second touch input; and
in response to the second touch input, initiating a secondary action while maintaining the cursor at the offset location.

6. The method of claim 5, wherein the secondary action comprises one of: drag operation, selection confirmation, and tool activation.

7. The method of claim 1, wherein the predefined threshold is configurable based on at least one of: user preference, application context, and device characteristics.

8. The method of claim 1, wherein computing the tension value comprises calculating a Euclidean distance between the starting point and the current location.

9. The method of claim 1, further comprising snapping the starting point to a nearest user interface element when the initial touch is detected within a predetermined proximity of the user interface element.

10. A system for precision touch input, the system comprising:
a touchscreen display configured to detect touch input;
a processor; and
a memory storing instructions that, when executed by the processor, cause the system to:
detect an initial touch at a first location on the touchscreen display;
store the first location as a starting point;
detect movement of the touch from the first location to a current location;
compute a tension value based on a distance between the starting point and the current location;
render a visual indicator that extends between the starting point and the current location, wherein at least one visual property of the visual indicator varies as a function of the tension value;
compare the tension value to a predefined threshold;
while the tension value is below the predefined threshold, maintain a cursor at the starting point; and
when the tension value meets or exceeds the predefined threshold:
modify the visual indicator to indicate an engaged state; and
enable movement of the cursor based on the current location with an offset from the current location such that the cursor is visually separated from the touch.

11. The system of claim 10, wherein the instructions further cause the system to dynamically adjust the predefined threshold based on application context.

12. The system of claim 10, wherein the touchscreen display comprises a capacitive multi-touch panel.

13. The system of claim 10, wherein the offset is computed to position the cursor in a direction away from a center of the touchscreen display relative to the current location.

14. The system of claim 10, wherein the instructions further cause the system to:
detect a second simultaneous touch input while the cursor is in the engaged state; and
initiate a drag operation using the cursor position as a starting point for the drag operation.

15. A non-transitory computer-readable medium storing instructions that, when executed by one or more processors of a computing device having a touchscreen display, cause the computing device to perform operations comprising:
detecting an initial touch at a first location on the touchscreen display;
storing the first location as a starting point;
detecting movement of the touch from the first location to a current location;
computing a tension value based on a distance between the starting point and the current location;
rendering a visual indicator that extends between the starting point and the current location, wherein at least one visual property of the visual indicator varies as a function of the tension value;
comparing the tension value to a predefined threshold;
while the tension value is below the predefined threshold, maintaining a cursor at the starting point; and
when the tension value meets or exceeds the predefined threshold:
modifying the visual indicator to indicate an engaged state; and
enabling movement of the cursor based on the current location with an offset from the current location such that the cursor is visually separated from the touch.

16. The non-transitory computer-readable medium of claim 15, wherein the operations further comprise providing haptic feedback when the tension value meets or exceeds the predefined threshold.

17. The non-transitory computer-readable medium of claim 15, wherein the operations further comprise scaling the offset distance based on a zoom level of content displayed on the touchscreen display.

18. The non-transitory computer-readable medium of claim 15, wherein the visual indicator comprises a line that transitions from a dashed pattern to a solid pattern as the tension value increases.

19. The non-transitory computer-readable medium of claim 15, wherein the operations further comprise:
detecting termination of the touch; and
in response to the termination, finalizing a cursor action at a final cursor position and resetting to an inactive state.

20. The non-transitory computer-readable medium of claim 15, wherein the operations further comprise applying the tension-based precision control across multiple application types including graphic design applications, text editing applications, and mapping applications.
